(19) United States
(12) Patent Application Publication
(10) Pub. No.: US 2006/0056426 A1
(43) Pub. Date: Mar. 16, 2006

(54) Access router and terminal device

(75) Inventors: Hiroshi Wakameda, Yokohama (JP); Yoshiyuki Seguchi, Yokohama (JP); Tomohide Yamamoto, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/031,721

(22) Filed: Jan. 7, 2005

(30) Foreign Application Priority Data
Sep. 15, 2004 (JP) JP2004-268427

(51) Int. Cl. H04L 12/56; H04L 12/28

(52) U.S. Cl. 370/401; 370/389

(57) ABSTRACT

An access router placed at an entrance of a core network to house an access network through which a host connects to the core network, including: a creating unit for creating network information which has control information to control connection of a host to the access network; and a transmitting unit for sending network information which has the control information to a host connected to the access network.

### BACKGROUND OF THE INVENTION

1. Field of the Invention

The present invention relates to an access router placed at an entrance of a core network or similar network to house an access network or the like through which a terminal device is connected to the core network or similar network, and to a terminal device (host).

2. Description of the Related Art

Our network environment has lately experienced a major change and a ubiquitous network society is just on the horizon. A ubiquitous network allows users to access the network at any time and location through any information terminal.

In fact, there are already networks setup in company offices, common households and outdoors (for instance, points from which a wireless LAN (local area network) is accessible). In particular, the rapidly growing popularity of the wireless LAN has enabled users to connect to the Internet with ease. This has prompted users to demand improved communication quality, and a stable, highly reliable broadband network is direly needed.

In order to provide a stable and reliable network, a network management technique such as SNMP (Simple Network Management Protocol) is applied to a router in a backbone network. With a network management technique, the communication quality is maintained by avoiding a failed network in communications in accordance with traffic, failure and congestion states. An example of technique of collecting traffic information for each path to avoid congestion is described in Patent Document 1. This technique is applied to a router for path control in which other routers are circumvented when the situation demands.

IPv6 (Internet Protocol version 6) has recently been standardized (RFC2460: Internet Protocol, Version 6 (IPv6)), and services based on IPv6 are now beginning to be provided. In an IPv6 network, a host has a function of automatically creating an IP address.

The host automatically creates an address using its own interface ID (identification, usually generated by MAC (Media access control) address) and network information which is notified from an access router at regular intervals. Then the host communicates via the access router that has sent the network information. The host keeps receiving network information from the access router periodically. This enables the host to continue communicating via the access router.

[Patent document 1] JP 2002-368787 A

[Non-Patent document 1] RFC (Request For Comment) 2460: Internet Protocol, Version 6 (IPv6)

[Non-Patent document 2] RFC (Request For Comment) 2462

Network management techniques between routers have already been established. However, there is no established technique to manage a host and another host between access routers considering the relation between an access router and a host in a wireless access network (an access network having wireless paths).

A user is thus forced to switch access points manually or stop communications when the communication quality deteriorates.

In addition, as long as network information is provided from an access router, a host in an IPv6 network accesses a network via this access router despite congestion in an access network or in an upper level network, or a failure in network equipment between an access router and an access point. There is also a possibility that a new host is connected and starts communications when network information is notified. As a result, the congestion or failure worseness instead of being solved and the IPv6 network may fail to ensure the communication quality to users' satisfaction.

A host in a wireless LAN, for example, has a function of automatically connecting, when a connection using a data link between the host and an access point is not available, to another data link (a function of searching for another access point). When the data link between the host and the access point is available, on the other hand, the host does not switch to another data link.

The host therefore cannot detect a network failure or congestion between the access point and an access router or in a level above the access router, with the result that paths are not switched.

### SUMMARY OF THE INVENTION

An object of the present invention is to provide an access router capable of controlling connection of a host to an access network.

Another object of the present invention is to provide a host whose connection to an access network is controlled in accordance with information from an access router.

The present invention employs following configurations to attain the objects.

That is, the present invention provides an access router placed at an entrance of a first network to house a second network through which a terminal device connects to the first network, including:

a creating unit for creating network information which has control information to control connection of a terminal device to the second network; and

a transmitting unit for sending network information which has the control information to a terminal device connected to the second network.

The control information may contain information for causing the terminal device to perform processing of disconnecting from the second network and to stop or interrupt communications with the access router (to create an incommunicable state in which, for example, data transmission to the access router is blocked by making an interface for the access router invalid).

The access router according to the present invention notifies the terminal device of network information containing control information. The terminal device is thus caused to perform processing of disconnecting from the second network in accordance with the control information. In this way, hosts under the control of the access router can be reduced in number.

Further, the present invention provides a terminal device connected via a second network to an access router, which is placed at an entrance of a first network, including:

a receiving unit for receiving network information from the access router via the second network;

a monitoring unit for monitoring reception of the network information; and

a connection/disconnection processing unit for performing processing of disconnecting from the second network when the monitoring unit does not detect reception of network information for a given period of time.

The host according to the present invention carries out processing of disconnecting from the second network when network information can no longer be received. The number of terminal devices under the control of the access router can thus be reduced.

Further, the present invention provides a terminal device connected via a second network to an access router, which is placed at an entrance of a first network, including:

a receiving unit for receiving network information which has control information from the access router via the second network;

an analyzing unit for analyzing the received network information which has control information; and

a connection/disconnection processing unit for performing processing of disconnecting from the second network in accordance with results of an analysis by the analyzing unit.

The host according to the present invention carries out disconnecting processing in accordance with an analysis result. The number of hosts belonging to the second network can thus be reduced.

The present invention is capable of causing a host to perform processing of disconnecting from the second network and accordingly reducing hosts under the control of the access router in number.

### BRIEF DESCRIPTION OF THE DRAWINGS

FIG. 1 is a diagram showing an example of the configuration of a network system that employs an access router and host according to the present invention;

FIG. 2 is an explanatory diagram of the format of a network information notification message according to the present invention;

FIG. 3 is a diagram showing an example of the configuration of an access router according to the present invention;

FIG. 4 is a diagram showing a data configuration example of an RA transmission information table (valid period information table);

FIG. 5 is a diagram showing a data configuration example of a network status association table;

FIG. 6 is a diagram showing a data configuration example of an access network information table;

FIG. 7 is a diagram showing a data configuration example of a network status management table;

FIG. 8 is a diagram showing a data configuration example of a connected terminal management table;

FIG. 9 is a diagram showing a data configuration example of a transmission interval table;

FIG. 10 is a diagram showing a sequence for creating a network information notification message;

FIG. 11 is a diagram showing the relation between function units in creating a network information notification message;

FIG. 12 is a diagram showing a sequence for sending a network information notification message upon reception of a network information request;

FIG. 13 is a diagram showing the relation between function units in sending a network information notification message upon reception of a network information request;

FIGS. 14A and 14B are diagrams showing a sequence 1 for sending a network information notification message upon detection of a change in state;

FIGS. 15A and 15B are diagrams showing a sequence 2 for sending a network information notification message upon detection of a change in state;

FIG. 16 is a diagram showing the relation between function units in sending a network information notification message upon detection of a change in state;

FIG. 17 is a diagram showing a sequence for sending a network information notification message for cyclic transmission;

FIG. 18 is a diagram showing the relation between function units in sending a network information notification message for cyclic transmission;

FIG. 19 is a diagram showing an example of the configuration of a host according to the present invention;

FIGS. 20A and 20B are diagrams showing a sequence 1 for switching data links due to excess of a network information request transmission count;

FIG. 21 is a diagram showing a sequence 2 for switching data links due to excess of a network information request transmission count;

FIG. 22 is a diagram showing the relation between function units in switching data links due to excess of a network information request transmission count;

FIGS. 23A and 23B are diagrams showing a sequence for judging the need to switch data links due to a change in network status;

FIG. 24 is a diagram showing the relation between function units in judging the need to switch data links due to a change in network status;

FIGS. 25A and 25B are diagrams showing a sequence for switching data links due to a change in network status;

FIG. 26 is a diagram showing the relation between function units in switching data links due to a change in network status;

FIG. 27 is an explanatory diagram of the format of a Router Advertisement message;

FIGS. 28A and 28B are detailed explanatory diagram of the format of a Router Advertisement message;

FIG. 29 is a diagram showing the format of option fields in a Router Advertisement message and details of the message;

FIG. 30 is a diagram showing a network status option format and details of the message; and

FIG. 31 is a diagram showing an access network information option format and details of the message.

### DETAILED DESCRIPTION OF THE PREFERRED EMBODIMENTS

An embodiment mode and embodiments of the present invention will be described below with reference to the drawings. The configurations of the following embodiment mode and embodiments are for exemplification purposes and the present invention is not limited to the configurations of the embodiment mode and embodiments.

### Embodiment Mode of the Invention

<Overall Configuration>

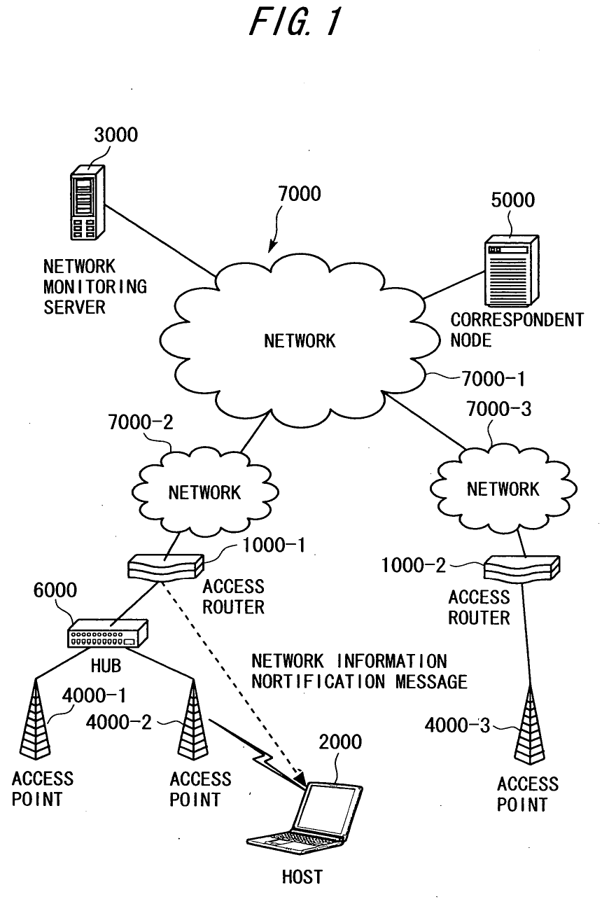

An embodiment mode of the present invention is described first. FIG. 1 is a diagram showing an example of the configuration of a network system to which an access router and host of the present invention are applied. Shown in FIG. 1 is a backbone (core) network 7000 (corresponding to a first network) to which a host 2000 of the present invention is connected to communicate with a correspondence node 5000.

The core network 7000 according to the example shown in FIG. 1 is built by connecting networks 7000-2 and 7000-3 to a network 7000-1. The networks 7000-2 and 7000-3 each have an access router 1000, which functions as a default gateway (entrance to the core network) for connecting the host 2000 to the network 7000. In the example of FIG. 1, the network 7000-2 has an access router 1000-1 whereas the network 7000-3 has an access router 1000-2.

An access network (corresponding to a second network) for the network 7000 is provided between each access router 1000 and the host 2000. The access networks have access points 4000, which establish wireless links (data links) with the host 2000. Each access router 1000 can have one or more access points 4000 directly or via a hub.

In the example of FIG. 1, the access router 1000-1 has access points 4000-1 and 4000-2 connected via a hub 6000 whereas the access router 1000-2 has an access point 4000-3. As a result, an access network leading to the access router 1000-1 via the access point 4000-1 or 4000-2 and an access network leading to the access router 1000-2 via the access point 4000-3 are built between the host and the core network 7000.

The host 2000 connects to any one of the access points 4000 via a wireless link (data link) to receive network information notification message from the access router 1000 that is above the chosen access point.

Using the network information notification message, the host 2000 creates its own address on the core network (for example, an IPv6 address), and connects to the network 7000 via the one of the access router 1000 that has sent the network information notification message to communicate with the correspondence node 5000.

The example of FIG. 1 show the host 2000 being connected to the access point 4000-2 to receive a network information notification message from the access router 1000-1, which is above the access point 4000-2.

A network monitoring server 3000 constantly monitors the state in the network 7000. The access router 1000 receives monitor notification, which contains results of monitoring by the network monitoring server 3000 and which is used to manage traffic, failure and congestion states in the network 7000. Such monitoring and management are achieved by SNTP or the like.

<Network Information Notification Message>

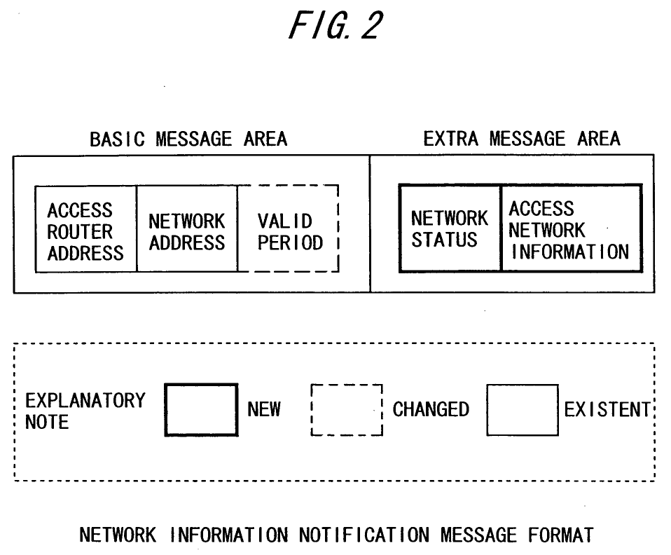

FIG. 2 is a diagram showing the format of a network information notification message which is notified to the host from the routers according to the present invention. The network information notification message in FIG. 2 has a basic message area and an extra message area.

The basic message area is an area for existing information. The basic message area stores an access router address, a network address, and a valid period. The extra message area is an area for information newly added in the present invention. The network status and access network information are newly added and stored in the extra message area. The valid period and the network status correspond to control information of the present invention. The access network information can also be treated as control information of the present invention.

The network information and access network information stored in the extra message area are ignored as in comprehensible information by a host whose configuration is not according to the present invention (hereinafter referred to as “conventional host”). The conventional host then utilizes the basic message area alone to give an interface an address and set network settings such as default gateway settings.

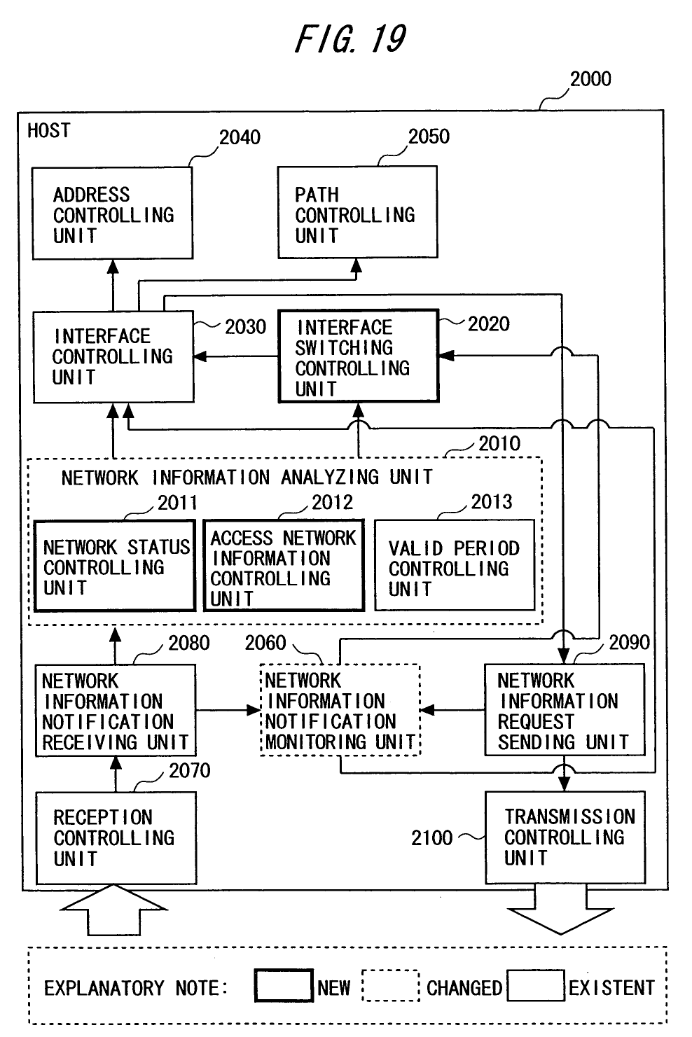

On the other hand, a host according to the present invention (FIG. 19) utilizes the network status and access network information added in the extra message area to switch to a better access network.

A network information notification message can be created by, for example, improving a Router Advertisement (RA) sent to a host from an access router in IPv6.

<Access Router Configuration>

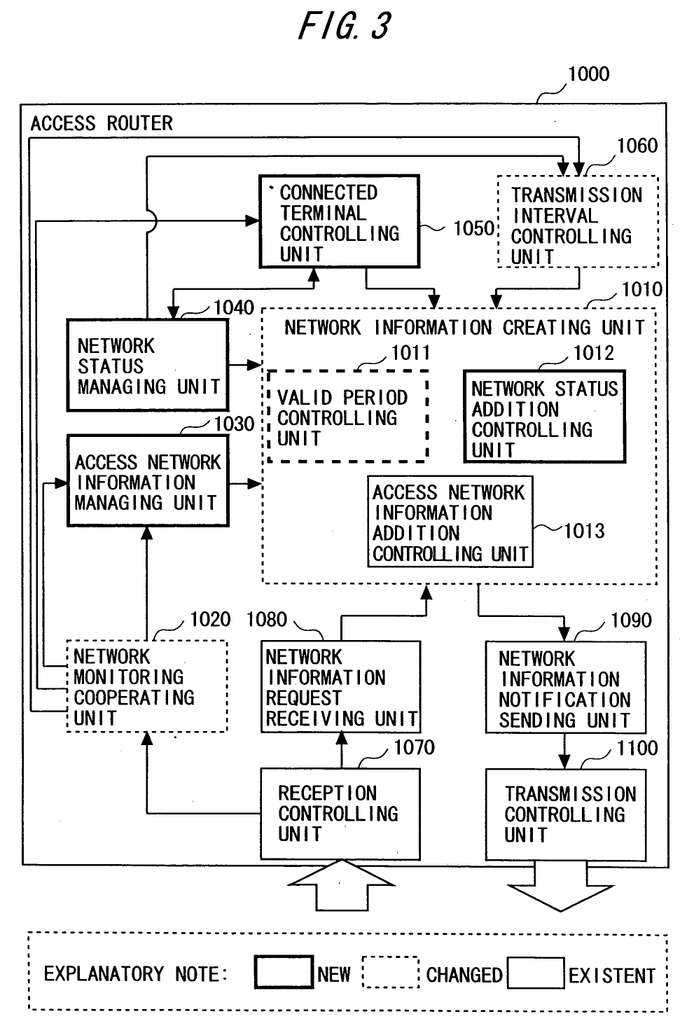

The configuration of an access router according to the present invention is described next. FIG. 3 is a diagram showing an example of the configuration of the access router 1000 according to the present invention (an access router embodiment mode). The access router configuration of FIG. 3 is applied to the access router 1000-1 and/or access router 1000-2 shown in FIG. 1.

The access router 1000 in FIG. 3 is composed of a network information creating unit (creating unit) 1010, a valid period controlling unit 1011, a network status addition controlling unit 1012, an access network information addition controlling unit 1013, a network monitoring coordinating unit 1020, an access network information managing unit 1030, a network status managing unit 1040, a connected terminal controlling unit 1050, a transmission interval controlling unit 1060, a reception controlling unit 1070, a network information request receiving unit (request receiving unit) 1080, a network information notification sending unit (notification sending unit) 1090, and a transmission controlling unit 1100.

The valid period controlling unit 1011 in the network information creating unit 1010, the network monitoring coordinating unit 1020, and the transmission interval controlling unit 1060 are function units improved in order to obtain an access router according to the present invention.

The network status addition controlling unit 1012 and the access network information addition controlling unit 1013 in the network information creating unit 1010, the access network information managing unit 1030, the network status managing unit 1040, and the connected terminal controlling unit 1050 are function units newly added in order to obtain an access router according to the present invention. Given below is a description on each function unit of the access router 1000.

<<Network Information Creating Unit>>

The network information creating unit 1010 creates a network information notification message which reflects the network status of the network 7000 or a similar backbone network and of an access network to which the host 2000 is connected (the unit 1010 corresponds to the creating unit of the present invention). The network information creating unit 1010 breaks into the valid period controlling unit 1011, the network status addition controlling unit 1012 and the access network information addition controlling unit 1013.

The valid period controlling unit 1011 determines, from the network status, a valid period of network information to notify and sets the date as the “valid period” of a network information notification message (FIG. 2). A valid period is determined by preparing a table where identification information of an interface from which a network information notification message is sent and network information notification message valid period information are stored in association with network status (a valid period search table), and by searching the table for an entry that is associated with the detected network status.

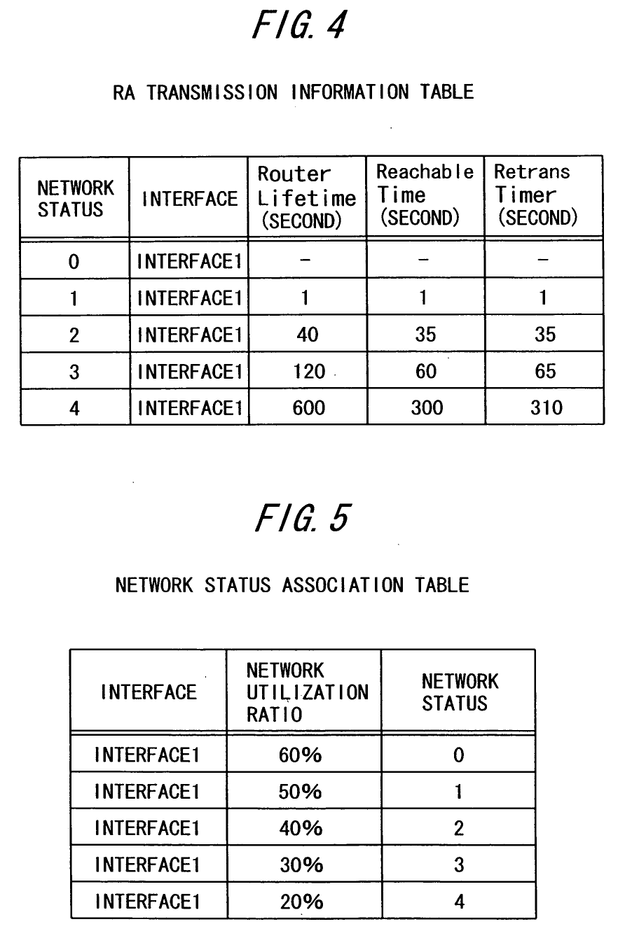

FIG. 4 is a diagram showing an example of an RA transmission information table as a specific example of the valid period search table. The RA transmission information table is created in a memory device inside the access router 1000 that is accessible to the valid period controlling unit 1011. The RA transmission information table in FIG. 4 has plural entries in association with the respective network status, and each entry includes an interface number as interface identification information, a router lifetime as valid period information, a possible arrival time, and a retransmission time.

The network status addition controlling unit 1012 sets information indicating the network status as the “network status” in the extra message area of a network information notification message (FIG. 2).

The access network information addition controlling unit 1013 sets information related to an access network as the “access network information” in the extra message area of a network information notification message (FIG. 2).

<<Network Monitoring Coordinating Unit>>

The network monitoring coordinating unit 1020 sends access network information and the network status to the access network information managing unit 1030 and the network status managing unit 1040, respectively, based on a network monitoring notification which is received from the network monitoring server 3000 (FIG. 1).

The network monitoring notification received from the network monitoring server 3000 contains “information indicating the (backbone) network status (e.g., the network utilization ratio)” and “access network information” indicating the state of an access network connected to the backbone network”.

The network monitoring coordinating unit 1020 holds an association table which shows an association between “information indicating the network status” contained in a network monitoring notification and a “network status” internally used by the access router 1000. The network monitoring coordinating unit 1020 derives a “network status” from “information indicating the network status” and notifies the network status managing unit 1040 of this network status.

FIG. 5 is a diagram showing an example of the configuration of a network status association table which corresponds to the association table described above. The network status association table in FIG. 5 stores network status (network status values) in association with the network utilization ratio of each backbone network side interface (an “interface 1” in FIG. 5) of the access router 1000 (the utilization ratio corresponds to “information indicating the network status”).

The network monitoring coordinating unit 1020 sends access network information to the access network information managing unit 1030. The network monitoring coordinating unit 1020 also notifies the connected terminal controlling unit 1050 and the transmission interval controlling unit 1060 of a change in network status.

<<Access Network Information Managing Unit>>

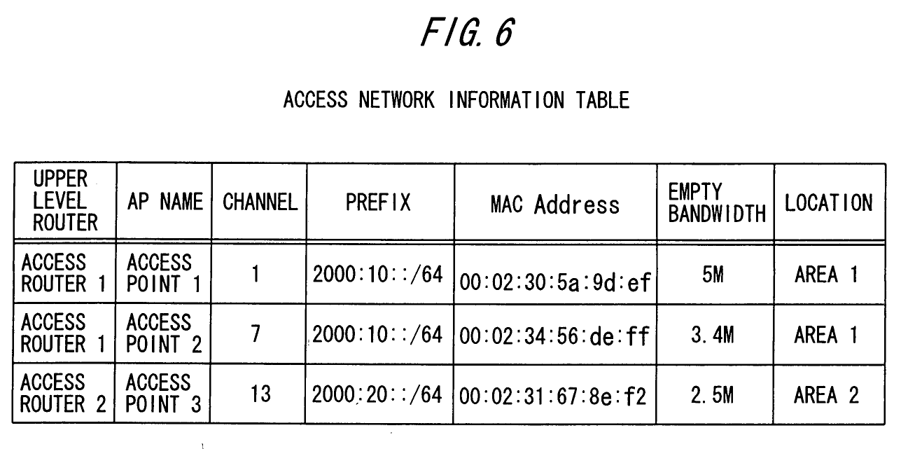

The access network information managing unit 1030 stores access network information sent from the network monitoring coordinating unit 1020 in an access network information table as the one shown in FIG. 6.

FIG. 6 is a diagram showing an example of the configuration of the access network information table. The access network information table in FIG. 6 is composed of one or more entries which are access network information and each of which contains as elements an upper level router, an access point (AP) name, a channel number, a prefix, an MAC address, free bandwidth, and a location.

The access network information managing unit 1030 sends access network information in response to an access network inquiry made by the network information creating unit 1010.

<<Network Status Managing Unit>>

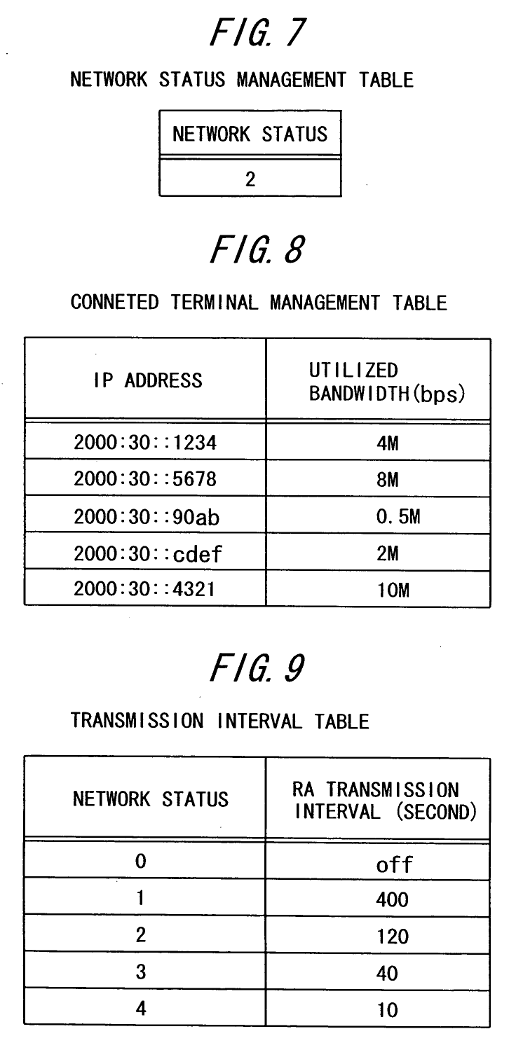

The network status managing unit 1040 stores the network status notified from the network monitoring coordinating unit 1020 in a network status management table as the one shown in FIG. 7. FIG. 7 is a diagram showing an example of the configuration of the network status management table. The network status management table in FIG. 7 has an area for storing the network status notified.

The network status managing unit 1040 notifies the network status in response to a network status inquiry made by the network information creating unit 1010, the connected terminal controlling unit 1050 and the transmission interval controlling unit 1060.

<<Connected Terminal Controlling Unit>>

The connected terminal controlling unit 1050 manages hosts connected to the access router 1000 and the traffic volume of each host using a connected terminal management table as the one shown in FIG. 8 (the unit 1050 corresponds to the host managing unit of the present invention). The connected terminal management table in FIG. 8 stores the IP address of each host connected to the access router 1000 and the bandwidth used (utilized bandwidth) in accordance with the IP address.

When notified of a change in network status by the network monitoring coordinating unit 1020, the connected terminal controlling unit 1050 uses the connected terminal management table to identify hosts that do not meet a communication quality and prompt these hosts to switch to other access networks.

<<Transmission Interval Controlling Unit>>

The transmission interval controlling unit 1060 controls the timing of sending network information such that network information notification messages are sent at regular intervals (the unit 1060 corresponds to the transmission interval determining unit of the present invention). When notified of a change in network status by the network monitoring coordinating unit 1020, the transmission interval controlling unit 1060 determines the length of the network information notification transmission cycle.

To determine the length of the cycle, the transmission interval controlling unit 1060 looks up a transmission interval table as the one shown in FIG. 9 for an RA transmission interval that is associated with a notified network status. The transmission interval controlling unit 1060 sends or stops network information notification messages in a cycle of the determined length. FIG. 9 is a diagram showing an example of the configuration of the transmission interval table. The transmission interval table in FIG. 9 stores RA transmission intervals in association with network status.

<<Reception Controlling Unit>>

The reception controlling unit 1070 receives a message sent from the outside. Messages sent from the outside include ones from hosts, ones from the network monitoring server, and ones from other access routers.

<<Network Information Request Receiving Unit>>

The network information request receiving unit 1080 receives a network information request message which is sent from a host and received by the reception controlling unit 1070. The network information request receiving unit 1080 requests the network information creating unit 1010 to create a network information notification message.

<<Network Information Notification Sending Unit>>

The network information notification sending unit 1090 receives a network information notification message created by the network information creating unit 1010. The network information notification sending unit 1090 requests the transmission controlling unit 1100 to send a network information notification message.

<<Transmission Controlling Unit>>

The transmission controlling unit 1100 sends messages to the outside. Messages sent to the outside include network information notification messages directed to hosts, messages for obtaining the network status, and the like.

Processing by the access router 1000 is described next.

<<First Processing>>

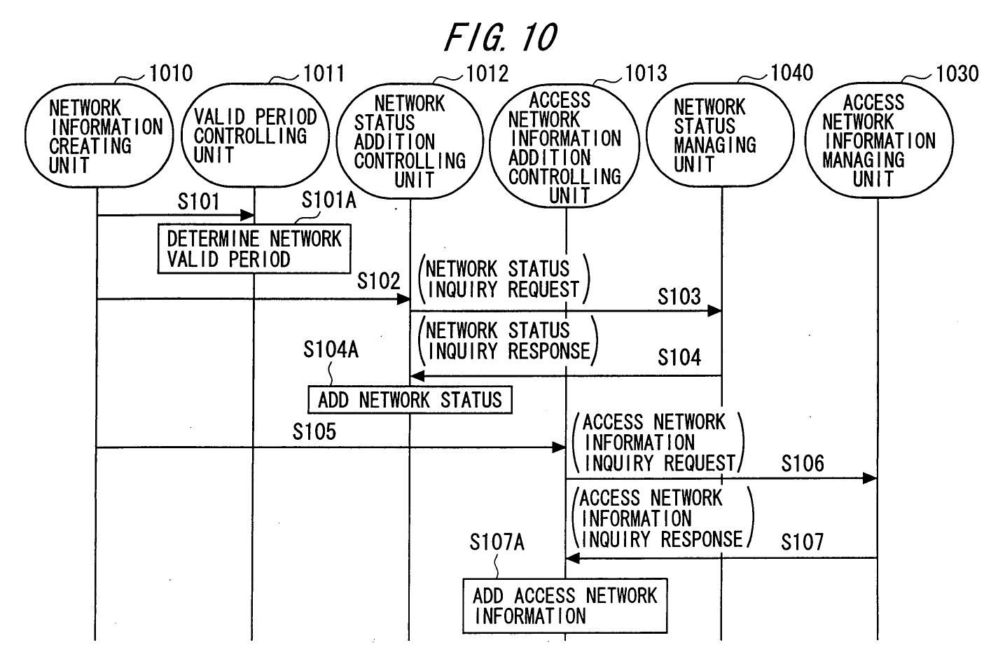

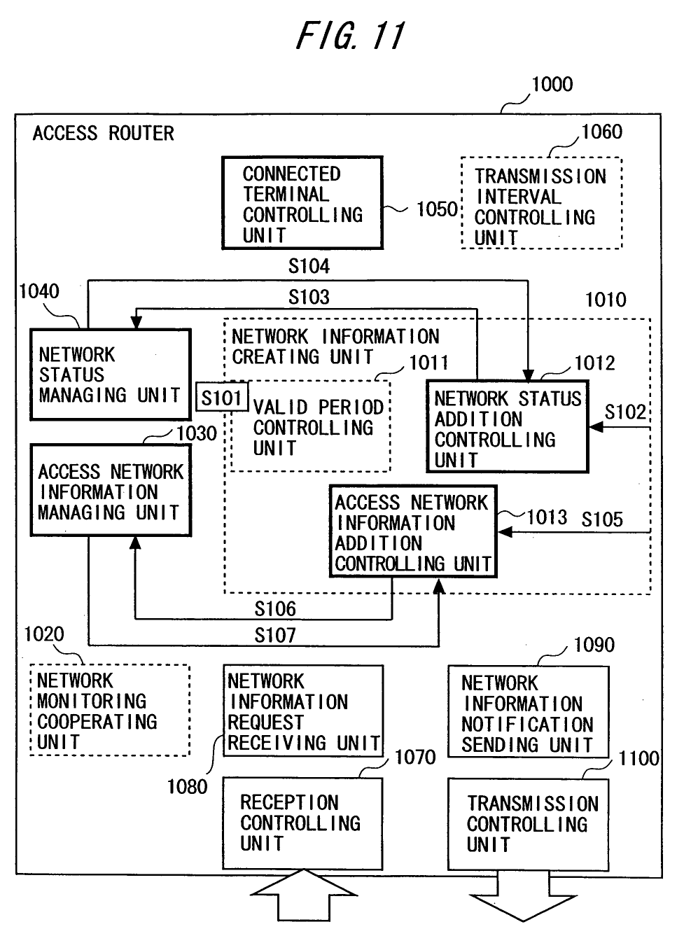

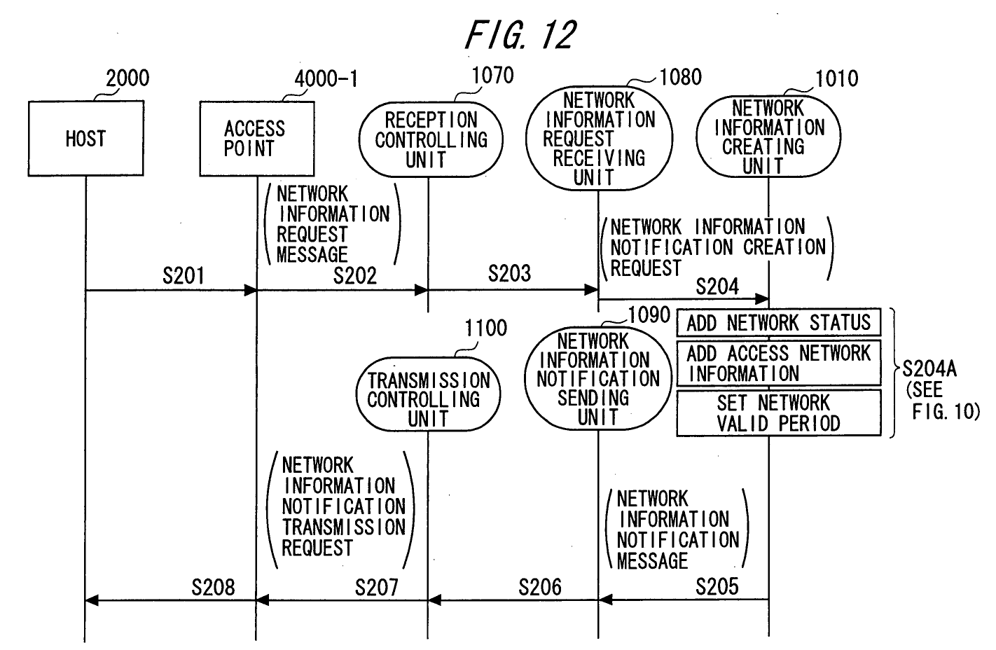

Described as first processing by the access router 1000 is processing of creating a network information notification message directed to a host. FIG. 10 is a diagram showing a network information notification message processing sequence which is performed by the access router 1000. FIG. 11 is a diagram showing function relations in the access router 1000 during creation of a network information notification message.

In FIGS. 10 and 11, the network information creating unit 1010 asks the valid period controlling unit 1011 to determine a valid period in accordance with the network status (Step s101). The valid period controlling unit 1011 determines, from the network status, the valid period of network information to be notified (Step s101A). The determined valid period is set by the valid period. controlling unit 1011 as the “valid period” in the network information notification message (FIG. 2).

The network information creating unit 1010 also asks the network status addition controlling unit 1012 to add the network status (Step s102). The network status addition controlling unit 1012 sends a network status inquiry request to the network status managing unit 1040 (Step s103) in order to inquire the network status.

The network status addition controlling unit 1012 receives a network status inquiry response from the network status managing unit 1040 (Step s104), and obtains the network status contained in the response. The network status is set by the network status addition controlling unit 1012 as the “network status” in the extra message area of the network information notification message (FIG. 2) (Step s104A).

Furthermore, the network information creating unit 1010 asks the access network information addition controlling unit 1013 to add access network information (Step s105). The access network information addition controlling unit 1013 sends an access network information inquiry request to the access network information managing unit 1030 (Step s106), and receives an access network information inquiry response in answer to the request (Step s107). In this way, the access network information addition controlling unit 1013 obtains access network information from the access network information managing unit 1030.

Then the access network information addition controlling unit 1013 sets the obtained access network information as the “access network information” in the extra message area of the network information notification message (FIG. 2) (Step s107A).

The access router 1000 sends a network information notification message created by the method described above when <1-1> a network information request message is received from a host, <1-2> there is a change in network status, and <1-3> it is time to send a network information notification message. The following description is about processing for the respective network information notification message transmission timing.

[Processing 1-1]

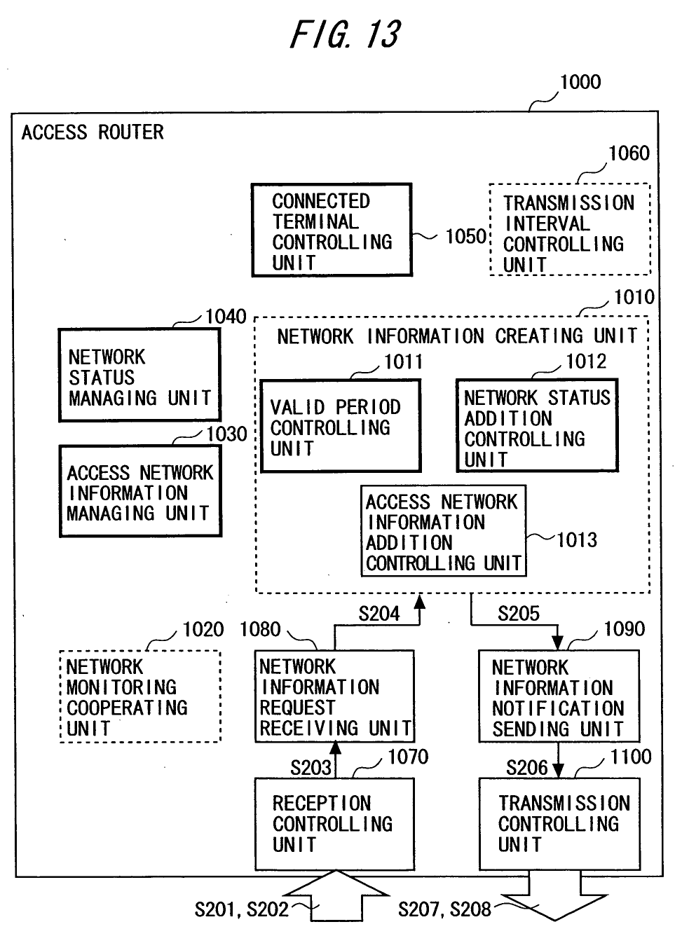

Described as processing 1-1 is network information notification message transmission processing that is started upon reception of a network information request message from a host. FIG. 12 is a diagram showing a processing sequence for when a network information request message is received from a host. FIG. 13 is a diagram showing function relations in the access router 1000 according to the processing 1-1.

The reception controlling unit 1070 of the access router 1000 receives a network information request message from the host 2000. The example shown in FIG. 12 is about a case where the host 2000 sends a network information request message to the access point 4000-1 (FIG. 1) (Step s201) and the access point 4000-1 forwards the network information request message to the access router 1000-1 (Step s202).

The reception controlling unit 1070 passes the network request message from the host 2000 to the network information request receiving unit 1080 (Step s203). Receiving the network information request message, the network information request receiving unit 1080 gives a network information notification creation request to the network information creating unit 1010 (Step s204).

Then the network information creating unit 1010 uses the method described with reference to FIG. 10 to create a network information notification message that fits (corresponds to) the access network (Step s204A). The network information creating unit 1010 sends, to the network information notification sending unit 1090, a network information transmission request that contains the created network information notification message (Step s205).

The network information notification sending unit 1090 responds to the network information transmission request and sends the network information notification message to the host 2000 that has sent the network information request message (Step s206).

The network information notification leaves the transmission controlling unit 1100 for the host 2000 (Step s207), and arrives at the host 2000 via the access point 4000-1 (Step s208).

[Processing 1-2]

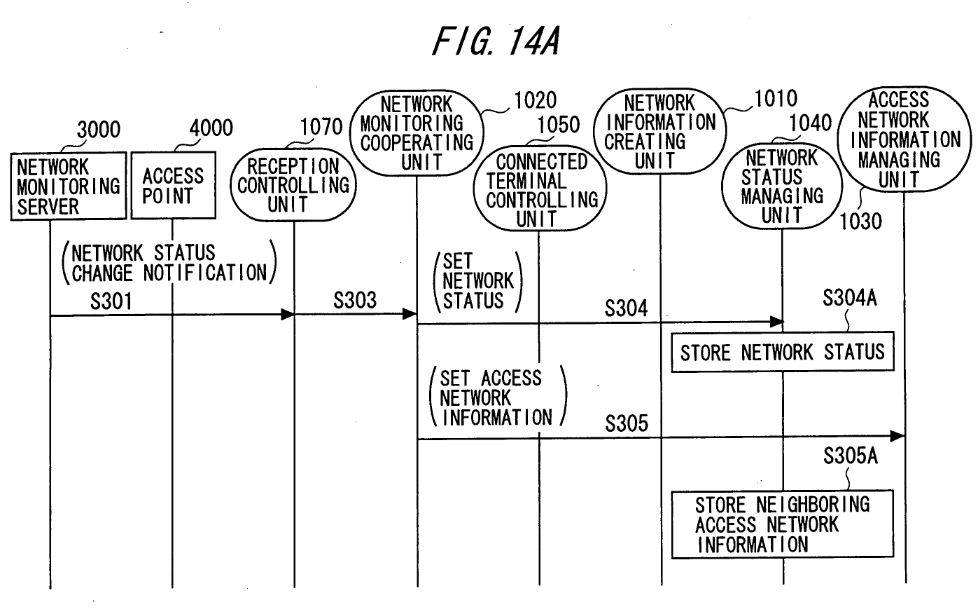

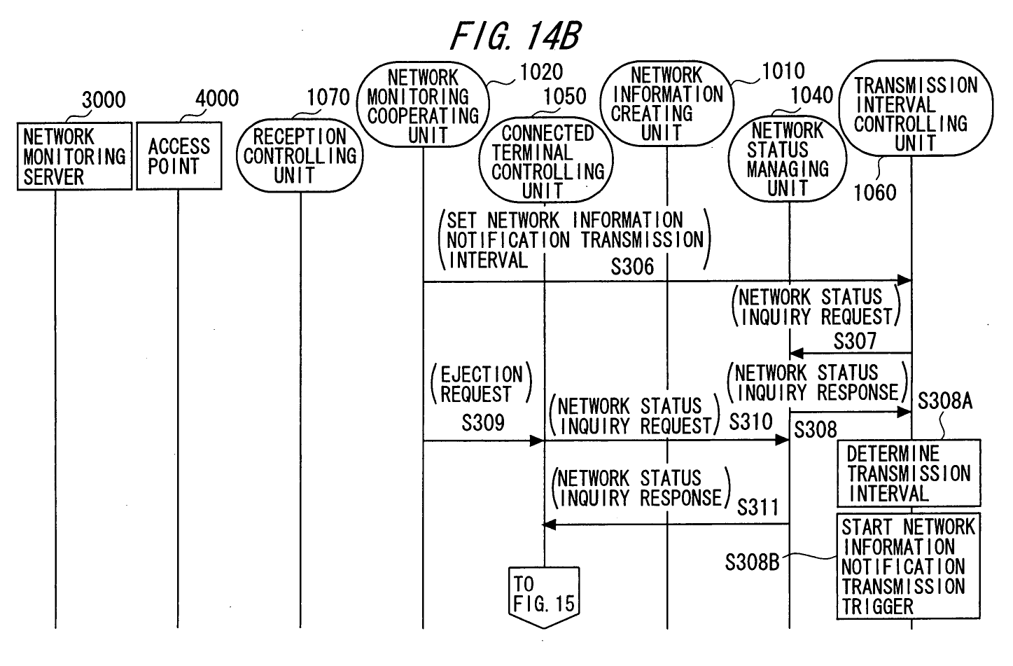

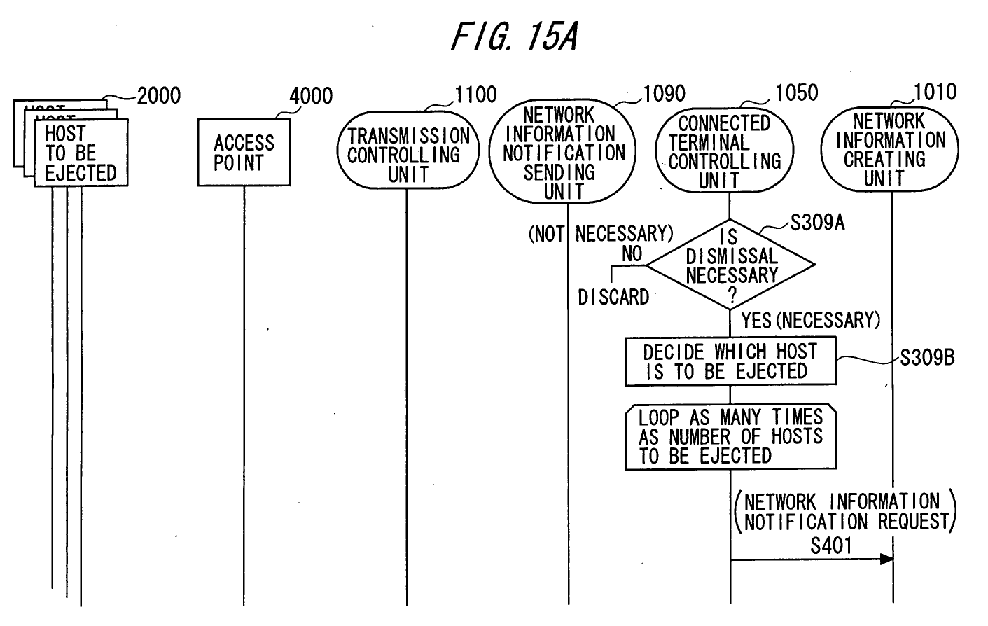

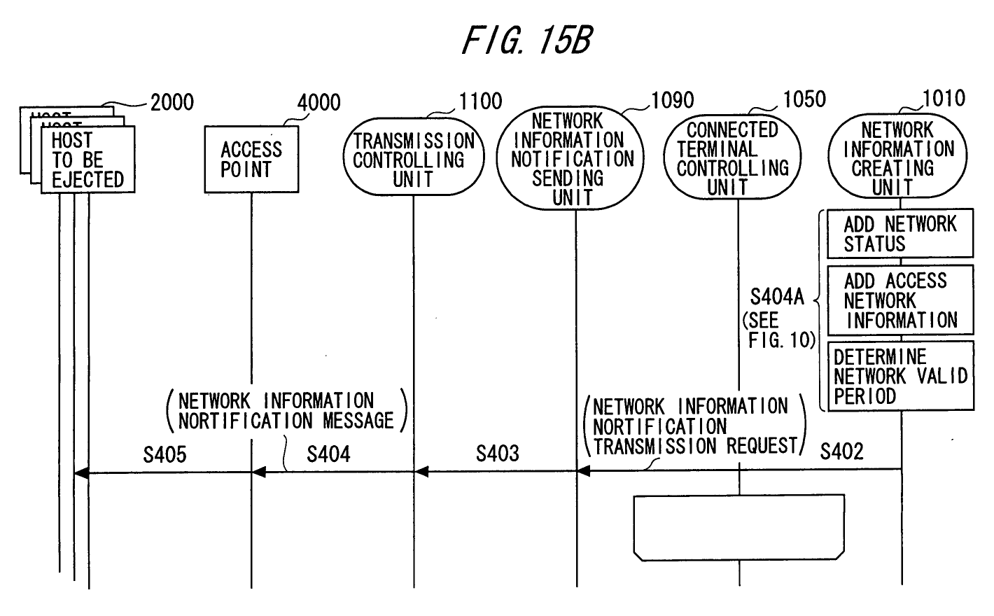

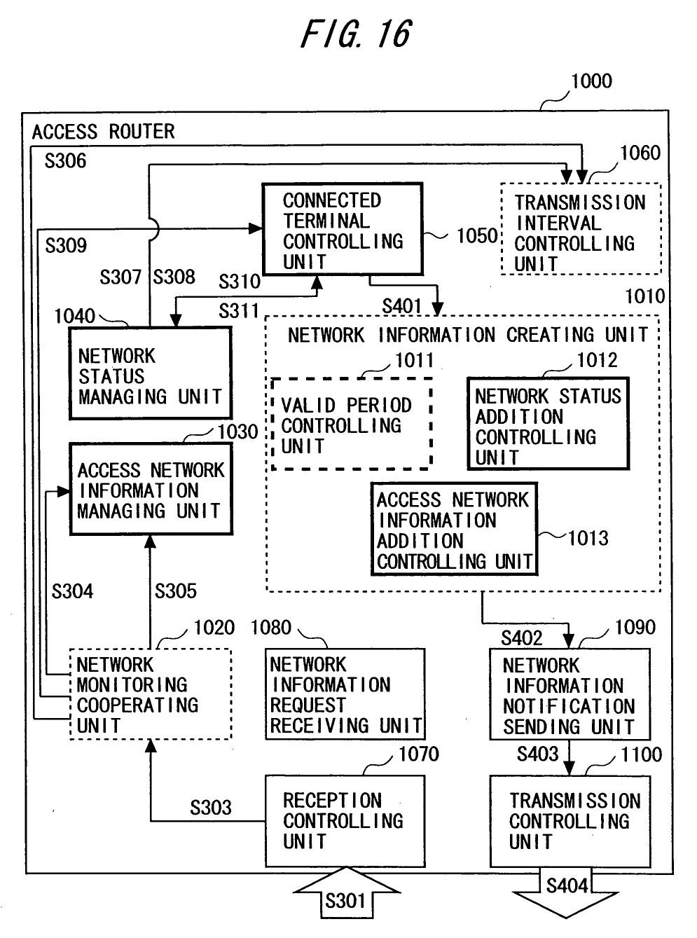

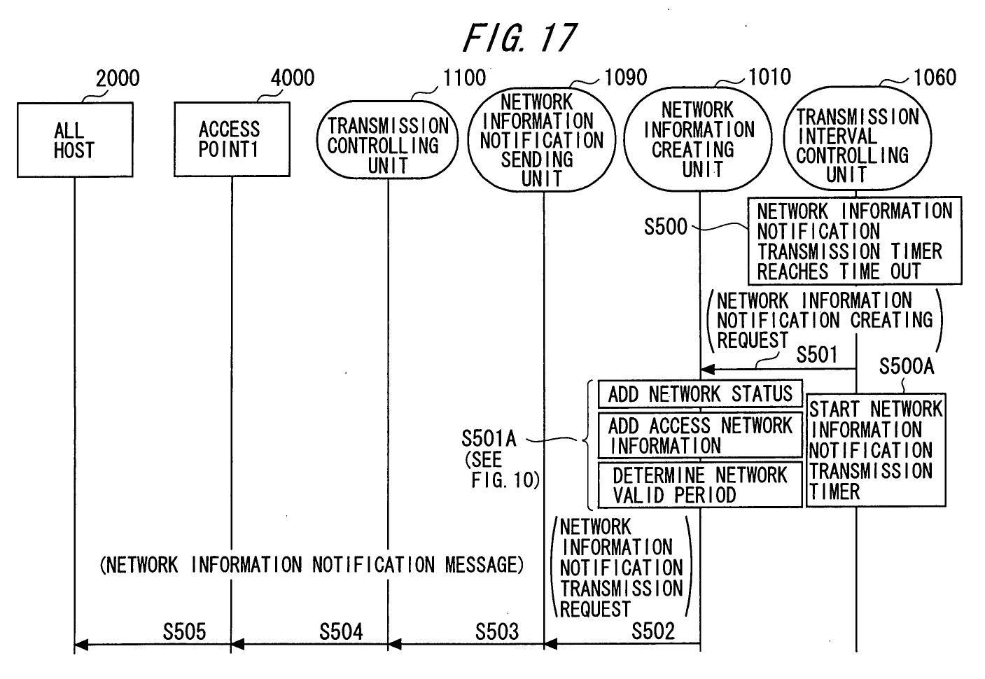

Described next as processing 1-2 is network information notification message transmission processing that is started by a change in network status. FIGS. 14 and 15 are diagrams showing a network information notification transmission processing sequence for when the network status has changed. FIG. 16 is a diagram showing function relations in the access router 1000 according to the processing 1-2.

When a change in network status is detected by the network monitoring server 3000, a network status change notification is sent from the network monitoring server 3000 (Step s301). The network status change notification is received by the reception controlling unit 1070 of the access router 1000. The reception controlling unit 1070 sends the network status change notification to the network monitoring coordinating unit 1020 (Step s303).

The network monitoring coordinating unit 1020 notifies the network status managing unit 1040 of the network status based on the network status change notification sent from the network monitoring server 3000 (Step s304). The network status managing unit 1040 keeps the notified network status (Step s304A).

The network monitoring coordinating unit 1020 also sends information of a neighboring access network to the access network information managing unit 1030 (Step s305). The access network information managing unit 1030 keeps the access network information sent (Step s305A).

The network monitoring coordinating unit 1020 notifies the transmission interval controlling unit 1060 of a change in network status (Step s306). The transmission interval controlling unit 1060 inquires the network status from the network status managing unit 1040. In other words, the transmission interval controlling unit 1060 sends a network status inquiry request to the network status managing unit 1040 (Step s307), and receives a network status inquiry response containing the network status from the network status managing unit 1040 (Step s308).

The transmission interval controlling unit 1060 determines the length of the network information notification transmission cycle from the received network status (Step s308A). Then the transmission interval controlling unit 1060 resumes transmission of network information notification messages in a cycle of the determined length (Step s308B).

Furthermore, the network monitoring coordinating unit 1020 sends, to the connected terminal controlling unit 1050, a dismissal (ejection) request containing information that indicates a change in network status (Step s309). The connected terminal controlling unit 1050 inquires the network status from the network status managing unit 1040. In other words, the connected terminal controlling unit 1050 sends a network status inquiry request to the network status managing unit 1040 (Step s310), and receives a network status inquiry response containing the network status from the network status managing unit 1040 (Step s311).

As shown in FIG. 15, the connected terminal controlling unit 1050 then investigates whether there is a host that no longer meets the communication quality after a change in network status or not. In other words, the unit 1050 judges whether it is necessary to dismiss a host or not (Step s311A). When it is judged that no host needs to be dismissed, the connected terminal controlling unit 1050 discards the dismissal request. When it is judged that dismissal of a host is necessary, on the other hand, the connected terminal controlling unit 1050 determines which host is to be dismissed (Step s311B).

A host decided by the connected terminal controlling unit 1050 as a host to be dismissed is one that cannot meet the communication quality. In the case where there are plural hosts that fit this definition, all of such hosts are decided as hosts to be dismissed.

The connected terminal controlling unit 1050 sends a network information notification creation request to the network information creating unit 1010 in order to prompt each host to be dismissed to switch to another access network (Step s401).

The network information creating unit 1010 creates a network information notification message that fits the access network (Step s401A; see FIG. 10), and sends to the network information notification sending unit 1090 a network information notification transmission request containing a network information notification message that is directed to a host to be dismissed (Step s402).

The network information notification sending unit 1090 responds to the network information notification transmission request and gives the network information notification message to the transmission controlling unit 1100 (Step s403). The transmission controlling unit 1100 sends the network information notification message (Step s404). The network information notification message arrives at the host to be dismissed via one of the access points 4000 that is connected to the host to be dismissed (Step s405).

Each host to be dismissed performs access network switching processing based on the network information notification message.

[Processing 1-3]

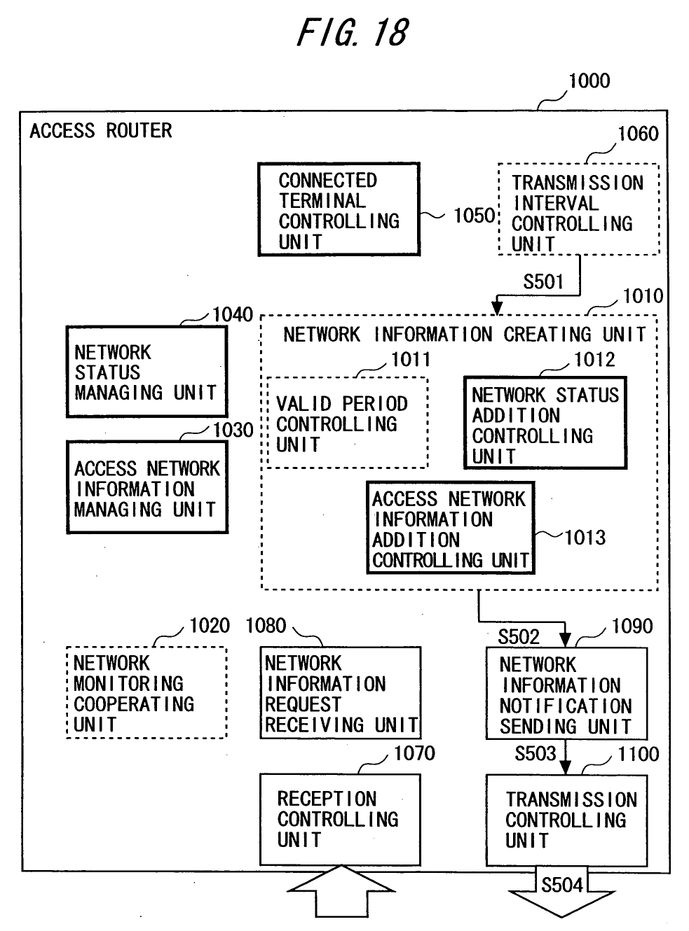

Described next as processing 1-3 is network information notification message transmission processing that is periodically performed by the access router 1000. FIG. 17 is a diagram showing a processing sequence for when a time to send a network information notification comes around during cyclic transmissions as the processing 1-3. FIG. 18 is a diagram showing function relations in the access router 1000 according to the processing 1-3.

The transmission interval controlling unit 1060 of the access router 1000 has a network information notification transmission timer for timing given transmission intervals between network information notification messages sent. It is when the network information notification transmission timer counts up to the specified length of time (time out) that a network information notification is sent, and the timing is controlled by the transmission interval controlling unit 1060 (Step s500).

When a time to send a network information notification comes around, the transmission interval controlling unit 1060 sends a network information notification creation request to the network information creating unit 1010 (Step s501). Thereafter, the transmission interval controlling unit 1060 starts (resumes) the counting (timing) by the network information notification transmission timer (Step s500A).

Upon receiving the network information notification creation request from the transmission interval controlling unit 1060, the network information creating unit 1010 creates a network information notification message that fits the access network (Step s501), and sends the network information notification message to every host in the access network.

In other words, a network information notification transmission request containing the network information notification message is sent from the network information creating unit 1010 to the network information notification sending unit 1090 (Step s502). The network information notification sending unit 1090 gives the network information notification message to the transmission controlling unit 1100 (Step s503).

The transmission controlling unit 1100 sends out the network information notification message directed to every host in the access network (Step s504). The network information notification message reaches all the hosts in the access network via appropriate access points 4000 (Step s505).

<Host Configuration>

A host according to the present invention is described next. FIG. 19 is a diagram showing an example of the configuration of a host according to the present invention, and the configuration is applied to the host 2000 in the network system shown in FIG. 1.

In FIG. 19, the host 2000 is composed of a network information analyzing unit (analyzing unit) 2010, a network status controlling unit 2011, an access network information controlling unit 2012, a valid period controlling unit 2013, an interface switching controlling unit (switching controlling unit) 2020, an interface controlling unit 2030, an address controlling unit 2040, a path controlling unit 2050, a network information notification monitoring unit (monitoring unit) 2060, a reception controlling unit 2070, a network information notification receiving unit (notification receiving unit) 2080, a network information request sending unit (request sending unit) 2090 and a transmission controlling unit 2100.

The valid period controlling unit 2013 in the network information analyzing unit 2010 and the network information notification monitoring unit 2060 are function units improved in order to achieve the present invention. The network status controlling unit 2011 and the access network information controlling unit 2012 in the network information analyzing unit 2010, and the interface switching controlling unit 2020 are function units newly added in order to achieve the present invention. Given below is a description on each function unit of the host 2000.

<<Network Information Analyzing Unit>>

The network information analyzing unit 2010 analyzes a network information notification message sent from the access router 1000 (the unit 2010 corresponds to the analyzing unit of the present invention). The network information analyzing unit 2010 breaks into the network status controlling unit 2011, the access network information controlling unit 2012 and the valid period controlling unit 2013.

The network status controlling unit 2011 analyzes the “network status” newly provided in the network information notification message (FIG. 2). The access network controlling unit 2012 analyzes the “access network information” newly provided in the network information notification message (FIG. 2). The “access network information” contains the network address of an access network, the address of an access point, the communication quality in the access network, and others. The valid period controlling unit 2013 analyzes the “valid period” contained in the network information message (FIG. 2).

<<Interface Switching Controlling Unit>>

The interface switching controlling unit 2020 switches data links. When access network information is set to a network information notification message and the relevant access network meets an expected communication quality, the interface switching controlling unit 2020 makes a switch to an access point that is specified by the access network information.

When access network information is not set to a network information notification message or the communication quality at the specified access point is below the expected level, the interface switching controlling unit 2020 searches through access points for one that has a satisfactory communication quality.

<Interface Controlling Unit>>

The interface controlling unit 2030 requests the address controlling unit 2040 to create an address and requests the path controlling unit 2050 to set a path table. The interface switching controlling unit and the interface controlling unit corresponds to the connection/switching processing unit of the present invention.

<<Address Controlling Unit>>

The address controlling unit 2040 creates an IP address using a network address obtained from a network information notification message and the MAC address of an interface.

<<Path Controlling Unit>>

The path controlling unit 2050 selects, as the gateway address of a default gateway, an access router address obtained from a network information notification message.

<<Network Information Notification Monitoring Unit>>

The network information notification monitoring unit 2060 monitors the latency from when a network information request message is sent until the corresponding network information notification message is received. Specifically, the network information notification monitoring unit 2060 manages a monitoring interval (monitored latency), a given period of time in which reception of a network information notification message is allowed. When a network information notification message is not received within the monitored latency, the network information notification monitoring unit 2060 retransmits the network information request message.

The network information notification monitoring unit 2060 also manages the number of times a network information request message is retransmitted. When the number of times a network information request message is retransmitted exceeds a certain number, the network information notification monitoring unit 2060 requests the interface switching controlling unit 2020 to switch data links. The network information notification monitoring unit 2060 corresponds to the monitoring unit of the present invention.

<<Reception Controlling Unit>>

The reception controlling unit 2070 receives a message sent from the outside. Messages sent from the outside include a network information notification message from an access router.

<<Network Information Notification Receiving Unit>>

The network information notification receiving unit 2080 receives a network information notification message from the reception controlling unit 2070 and requests the network information analyzing unit 2010 to analyze the network information notification message (the unit 2080 corresponds to the receiving unit of the present invention.

<<Network Information Request Sending Unit>>

The network information request sending unit 2090 requests the transmission controlling unit 2100 to send a network information request message.

<<Transmission Controlling Unit>>

The transmission controlling unit 2100 sends messages to the outside. Messages sent to the outside include a network information request message.

<Processing by Host>

Processing by the host 2000 is described next. The host 2000 switches data links when <2-1> a network information notification message cannot be received from an access router, and <2-2> a change in network status causes an unacceptable drop in communication quality. The following description is about processing in the host 2000 for the respective data link switching timing.

[Processing 2-1]]

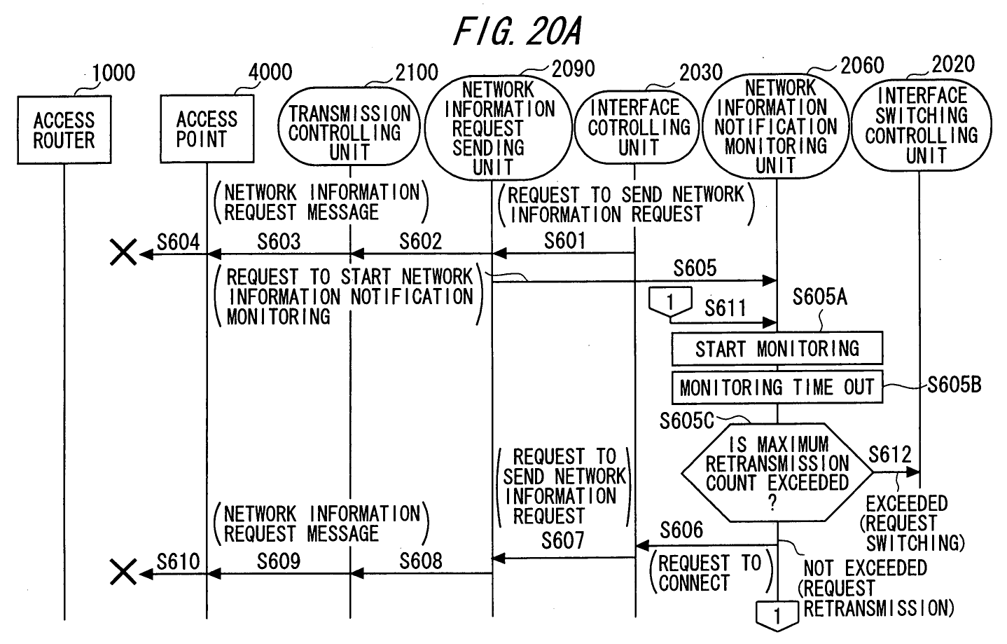

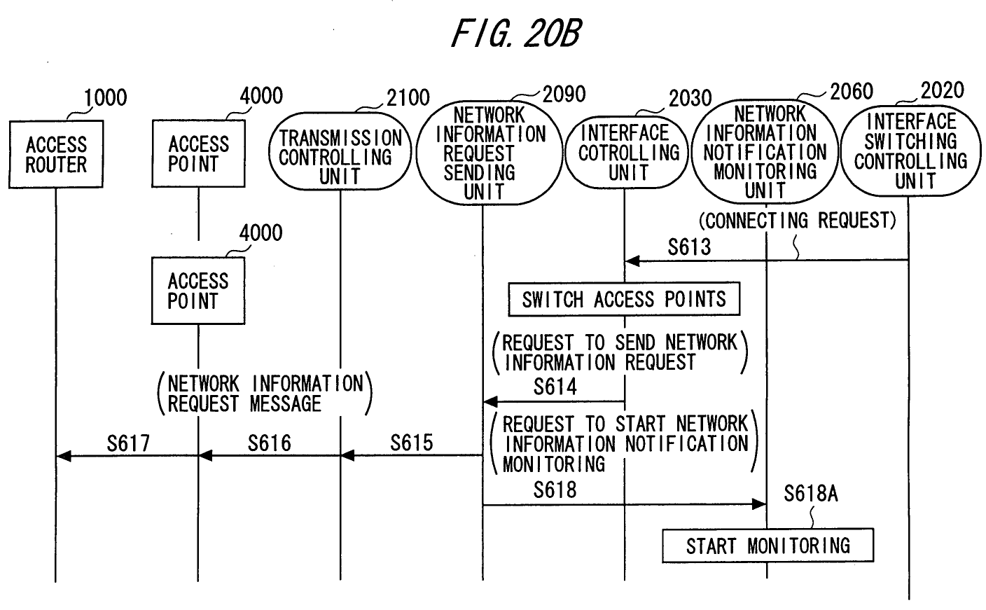

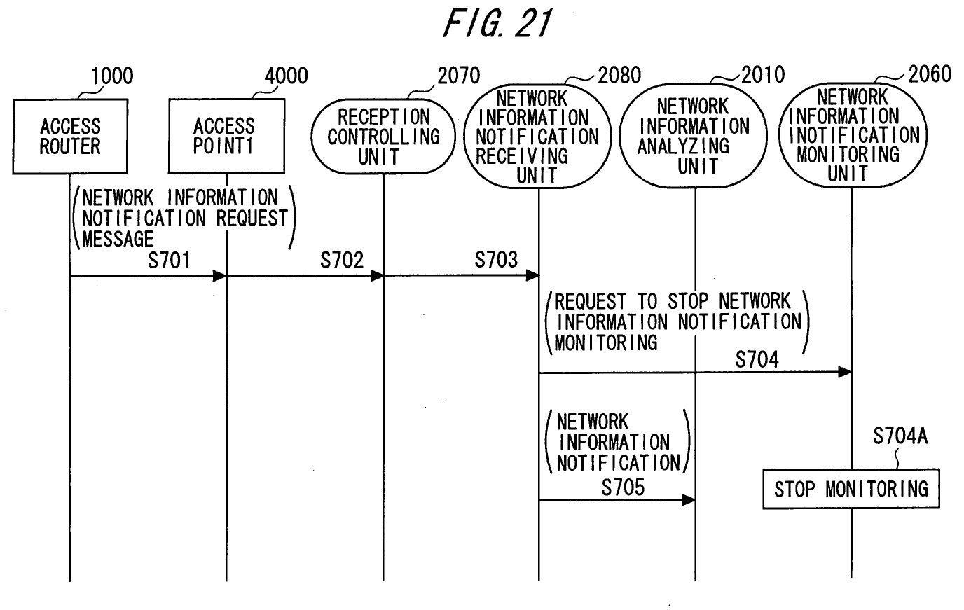

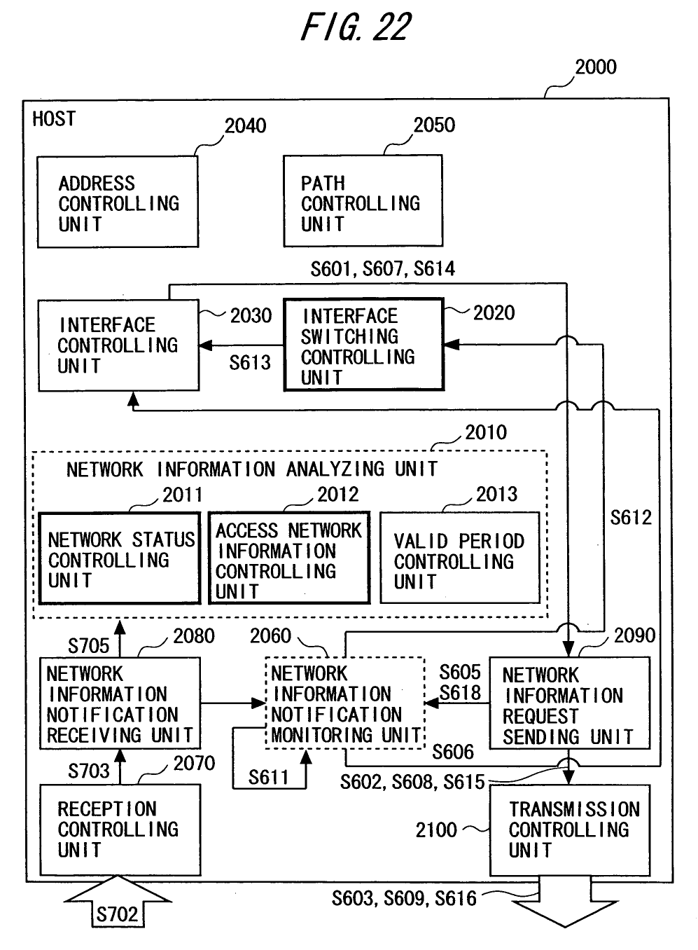

Described as processing 2-1 by the host 2000 is processing for when a network information notification message from an access router cannot be received by the host 2000. FIGS. 20 and 21 are diagrams showing a processing sequence for when reception of a network information notification message from an access router has failed. FIG. 22 is a diagram showing function relations in the host 2000 according to the processing 2-1.

When the valid period contained in an already received network information notification message expires, or a given period of time within the valid period has elapsed, the host 2000 sends a network information request message to the relevant access network and starts monitoring the latency until the corresponding network information notification message is received.

To elaborate, the interface controlling unit 2030 requests the network information request sending unit 2090 to transmit a network information request (Step s601). The network information request sending unit 2090 responds to this transmission request and creates a network information request message, which is given to the transmission controlling unit 2100 (Step s602).

The transmission controlling unit 2100 sends the network information request message to an access router via the access network (Step s603). The network information request message passes one of the access points 4000 and is directed to the access router that is above this access point (Step s604).

The example shown in FIGS. 21 and 22 is about a case where the network information request message is sent to the access router 1000-1 of FIG. 1 which has the access points 4000-1 and 4000-2. In Step s603, the network information request message is sent to the access point 4000-2 where a data link is currently established.

After sending the network information request message, the network information request sending unit 2090 requests the network information notification monitoring unit 2060 to start network information notification monitoring (Step s605).

Receiving the request to start monitoring, the network information notification monitoring unit 2060 starts monitoring a network information notification message sent in response to the network information request message (Step s605A). In other words, the network information notification monitoring unit 2060 has the timer it manages start counting the time for monitored latency. The time count by the timer is ended when the network information notification message is received by the network information notification receiving unit 2080 and the reception of the network information notification message is notified to the network information notification monitoring unit 2060 from the network information notification receiving unit 2080.

When the timer counts up to the specified monitored latency (time out) without the reception notification arriving from the network information notification receiving unit (Step s605B), the network information notification monitoring unit 2060 judges whether the number of transmitting or retransmitting the network information request message has exceeded a given number or not (Step S605C).

The network information notification monitoring unit 2060 is structured to count the number of times a network information notification message is transmitted or retransmitted, and manages a given number that is to be compared with the transmission or retransmission count. In Step s605C, the network information notification monitoring unit 2060 compares the transmission or retransmission count against the given number to judge whether the transmission or retransmission count exceeds the given number or not.

In the case where the transmission or retransmission count is under the given number, the network information notification monitoring unit 2060 requests the interface controlling unit 2030 to retransmit the network information request message (Step s606).

Receiving the retransmission request, the interface controlling unit 2030 requests the network information request sending unit 2090 to send the network information request that contains the network information request message to be retransmitted (Step s607).

The network information request sending unit 2090 responds to the transmission request and sends the network information request message to the transmission controlling unit 2100 (Step s608). The transmission controlling unit 2100 retransmits the network information request message to the access router (Step s609). The network information request message is thus retransmitted to the access router 1000 through the appropriate one of the access points 4000. This retransmission operation is repeated until the corresponding network information notification message is received or the number of times the network information request message is sent or retransmitted exceeds the given number.

When detecting that the number of times the network information request message is transmitted or retransmitted exceeds the given number, the network information notification monitoring unit 2060 requests the interface switching controlling unit 2020 to switch data links (Step s612).

The interface switching controlling unit 2020 responds to the switching request made by the network information notification monitoring unit 2060, and sends, to the interface controlling unit 2030, a request to connect to a different access point (Step s613). Thus data links are switched.

The interface controlling unit 2030 responds to the connection request and switches data links (access points) (Step s613A). For instance, the access point to which the host 2000 is connected is switched from the access point 4000-2 to the access point 4000-1.

After the data link switching is completed, the interface controlling unit 2030 requests the network information request sending unit 2090 to send a network information request on the new data link (Step s614).

The network information request sending unit 2090 creates and sends the network information request message (Step s615). The network information request message is sent from the transmission controlling unit 2100 (Step s616), and reaches the access router 1000 (here, the access router 1000-1) via the new access point 4000-1 (Step s617).

After sending the network information request message, the network information request sending unit 2090 requests the network information notification monitoring unit 2060 to start monitoring as in Step s615 (Step s618). The network information notification monitoring unit 2060 starts monitoring the latency until the corresponding network information notification message is received (Step s618A).

When the network information request message sent from the host 2000 is received by the access router 1000-1 via the access point 4000-1 in Step s616, the access router 1000-1 creates a network information notification message in response to the network information request message and sends the created message to the host 2000 (FIG. 21, Step s701).

The network information notification message is received by the reception controlling unit 2070 of the host 2000 via the access point 4000-1 (Step s702). The reception controlling unit 2070 gives the network information notification message to the network information notification receiving unit 2080 (Step s703).

Then the network information notification receiving unit 2080 sends a network information notification monitoring stopping request (stopping request) to the network information notification monitoring unit 2060 (Step S704). The network information notification monitoring unit 2060 responds to the stopping request and stops monitoring reception of the network information notification message (time counting by the timer) (Step s704A).

The network information notification receiving unit 2080 also gives the network information notification message to the network information analyzing unit 2010 (Step s705). The network information analyzing unit 2010 analyzes the network information notification message. An address is given to the interface and the default gateway is set in accordance with results of the analysis.

[Processing 2-2]

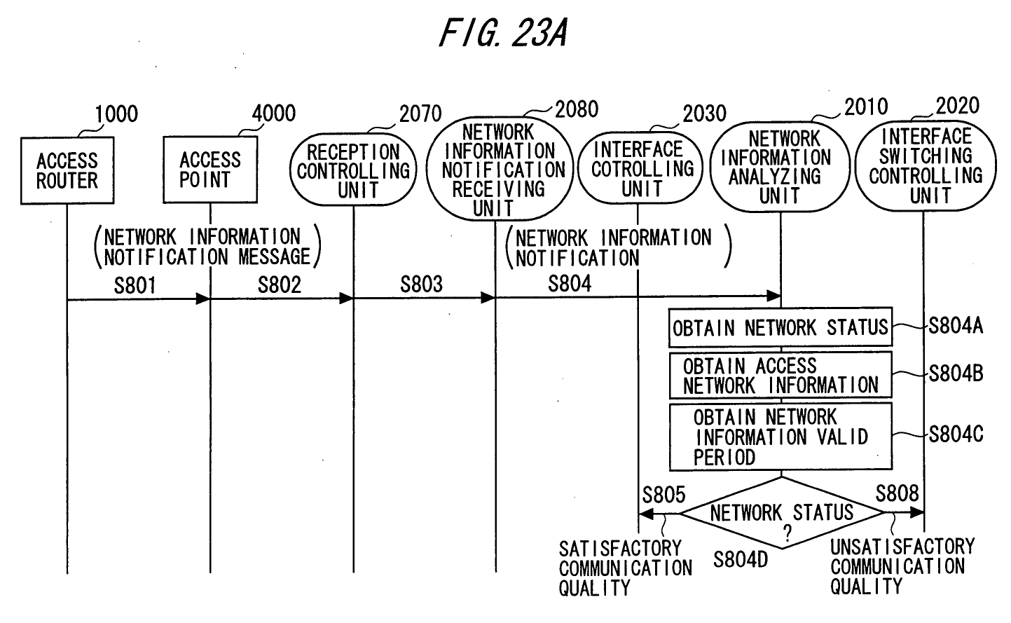

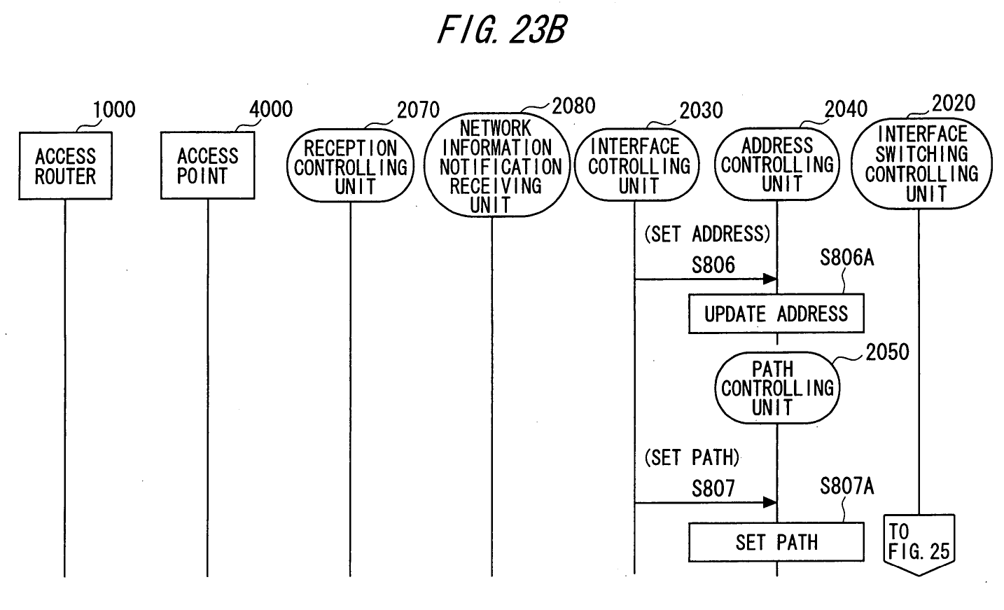

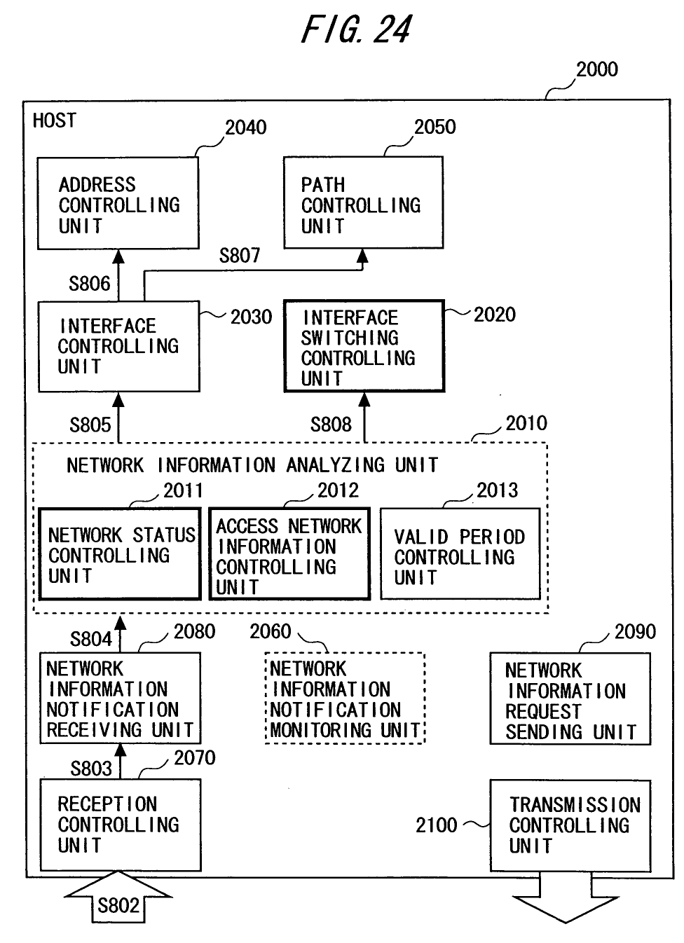

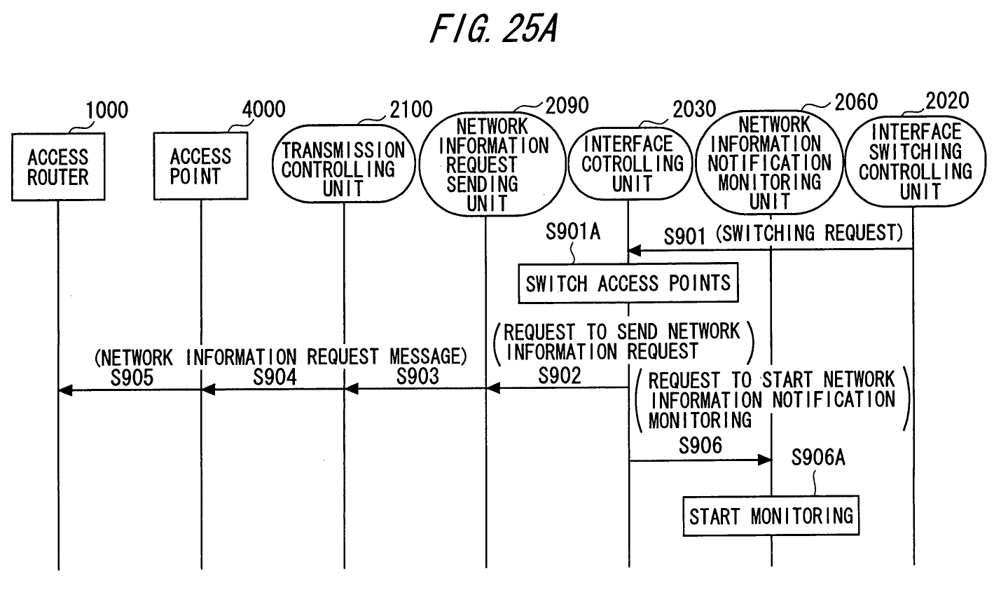

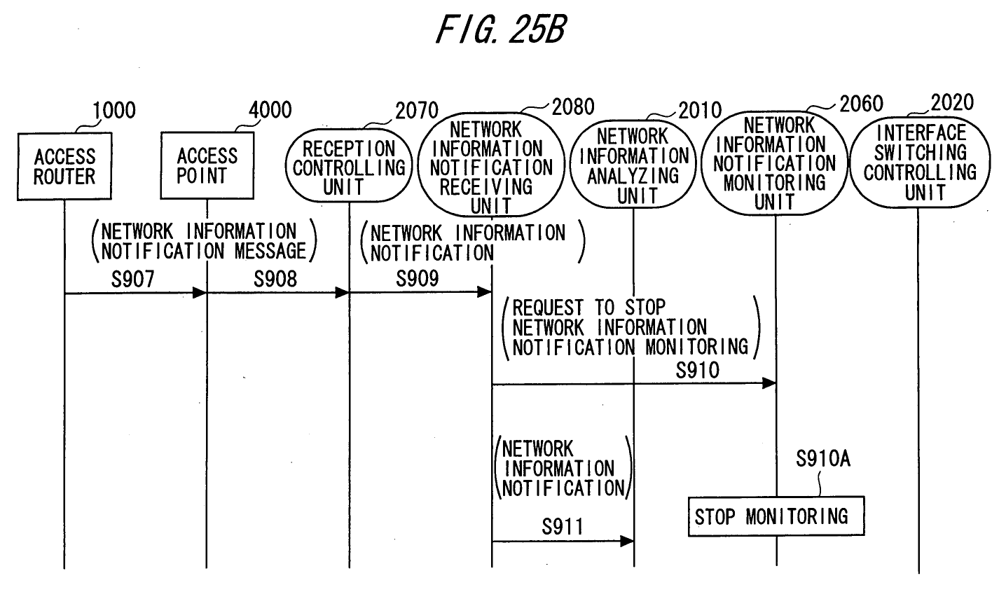

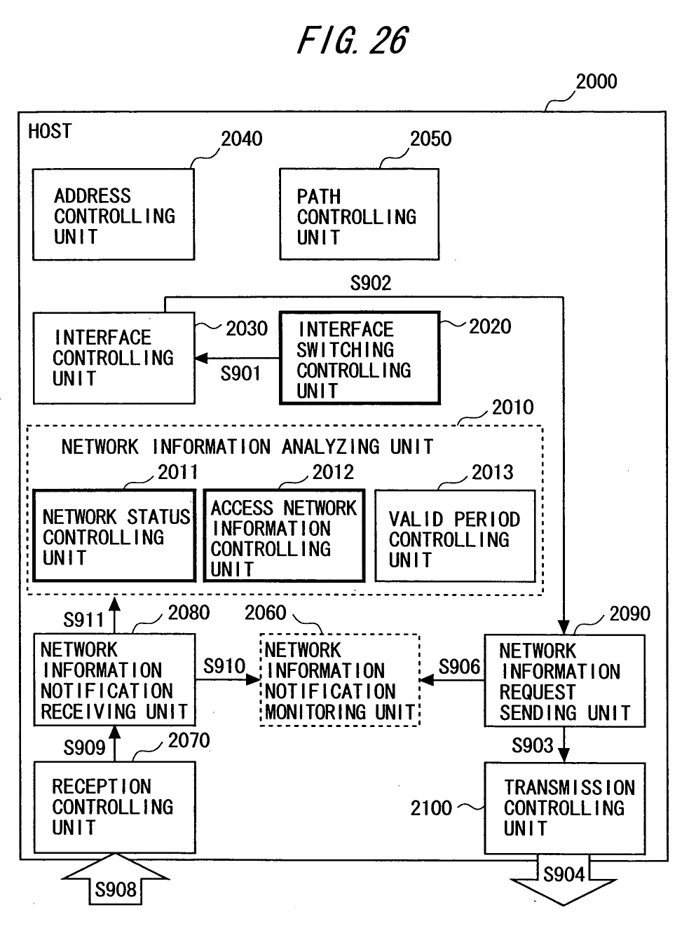

Described next as processing 2-2 by the host 2000 is processing for when a change in backbone network status makes it impossible to maintain the communication quality. FIGS. 23 and 25 are diagrams showing a host processing sequence for when the network status is changed such that the communication quality drops to an unacceptable level. FIGS. 24 and 26 are diagrams showing function relations in the host according to the processing 2-2.

The access router 1000 sends a network information notification message which has the format shown in FIG. 2 at the given transmission timing described above (Step s801). The network information notification message is received by the reception controlling unit 2070 of the host 2000 via one of the access points 4000 that is connected to the host 2000 (for example, the access point 4000-2) (Step s802).

The network information notification message received by the reception controlling unit 2070 is given to the network information notification receiving unit 2080 (Step s803). The network information notification receiving unit 2080 gives the network information notification message to the network information analyzing unit 2010 (Step s804). The network information analyzing unit 2010 analyzes the network information notification message.

Specifically, the network status controlling unit 2011 in the network information analyzing unit 2010 obtains the “network status” set in the extra message area of the network information notification message (FIG. 2) (Step s804A). At the same time, the “access network information” (FIG. 2) indicating to which access network the host 2000 can be connected is obtained from the network information notification message by the access network information controlling unit 2012. Also, the valid period controlling unit 2013 obtains the “valid period” of the network information notification message (FIG. 2).

The network information analyzing unit 2010 then judges whether or not the currently used access network meets the communication quality that the host 2000 desires from the network status contained in the network information notification message (Step s804D).

When the desired communication quality is met (Step s805), the interface controlling unit 2030 is notified of this fact and sends, to the address controlling unit 2040, an address setting request for requesting to create the IP address of the host 2000 (Step s806).

The address creating unit 2040 responds to the address setting request and creates the IP address of the host 2000 from a network address contained in the network information notification message and the MAC address or interface ID (created from the MAC address) of the interface (Step s806A). At this point, the valid period of the IP address of the interface is updated with the valid period notified by the network information notification message.

The interface controlling unit 2030 sends a path setting request to the path controlling unit 2050 (Step s807). The path controlling unit 2050 responds to the path setting request and chooses the IP address of the access router 1000 that is contained in the network information notification message as the gateway address of the default gateway (Step s807A).

On the other hand, when it is judged in Step s804D that the desired communication quality is not met, the interface switching controlling unit 2020 is requested to switch (Step s808). Upon this request, the interface switching controlling unit 2020 requests the interface controlling unit 2030 to connect as shown in FIGS. 25 and 26 (Step s901). Thus data links (access points) are switched (Step s901A). For instance, a switching is made from the access point 4000-2 to the access point 4000-3.

After the data link switching is completed, a network information request message is sent on the new data link (Steps s902, s903, s904, and s905), and monitoring of the latency until the corresponding network information notification message is received is started (Steps s906 and 906A).

When the network information notification message is successfully received from the access router 1000 (here, the access router 1000-2) (Steps s907, s908, and s909), monitoring of the latency until the corresponding network information notification message is received is ended (Steps s910 and s910A).

Thereafter, the network information notification message is analyzed (Step s911) to give an address to the interface and set the default gateway. The operation in Steps s902 to s911 is the same as the operation in Steps s614 to s618A and Steps s701 to s705 shown in FIGS. 20 and 21.

[Effect]

<Effect of Access Router>

The access router 1000 according to the present invention is capable of dynamically changing network information to be sent to a host, and the interval of sending network information notification messages as well.

In conventional hosts, an interface is made invalid when no network information notification message is received for a given period of time and the valid period of the network information expires. Taking this into consideration, the access router 1000 is allowed to play a leading role in making it impossible to give an address to any host depending on the state in an access network and thereby preventing the hosts from connecting to the access network. The network load is thus lightened.

<Effect of Host>

The host 2000 according to the present invention switches data links when a network information notification message that answers a network information request message is not received for a given period of time. In this way, the host 2000 can communicate using another access network.

<Using Access Router and Host Simultaneously>

In the case where the access router 1000 and host 2000 according to the present invention are used at the same time, a failure and congestion in an access network are recognized from network information and access network information, or the network status or access network information, added to a network information notification message, and thus a better access network can be find.

The host 2000 switches data links to connect to an access point of a better access network. In this way, the host 2000 can automatically connect to a more appropriate access network. The host 2000 may be switched back to the pre-switching access network when the original access network recovers.

This saves users the trouble of manually changing access networks which requires a special knowledge to identify the location of a failure or congestion. It also improves the communication quality. In addition, it enables an access router to dismiss only specific hosts in stages.

### Embodiments of the Present Invention

The embodiment mode of the present invention will be described in more detail through embodiments. In the following descriptions of the embodiments, as regulated in RFC2460 (Internet Protocol, Version 6 (IPv6)), a router advertisement (RA) is employed as a network information request message that is sent from an access router to a host whereas Router Solicitation (hereinafter referred to as “RS”) is employed as a network information request message with which a host requests an access router to send a network information notification message.

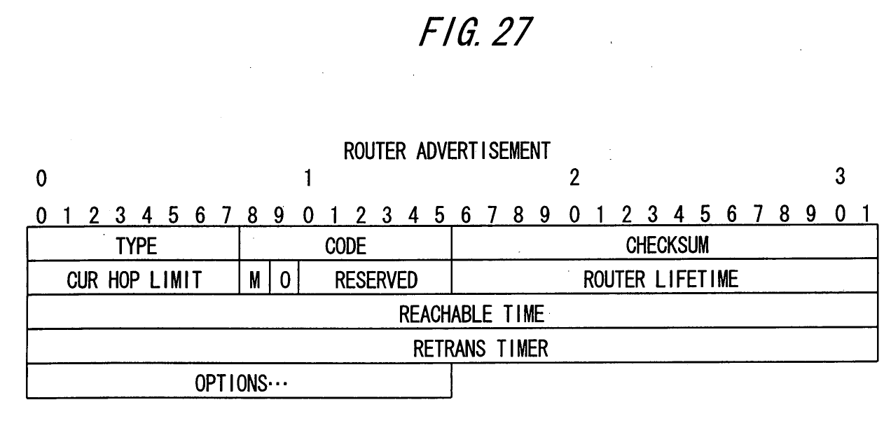

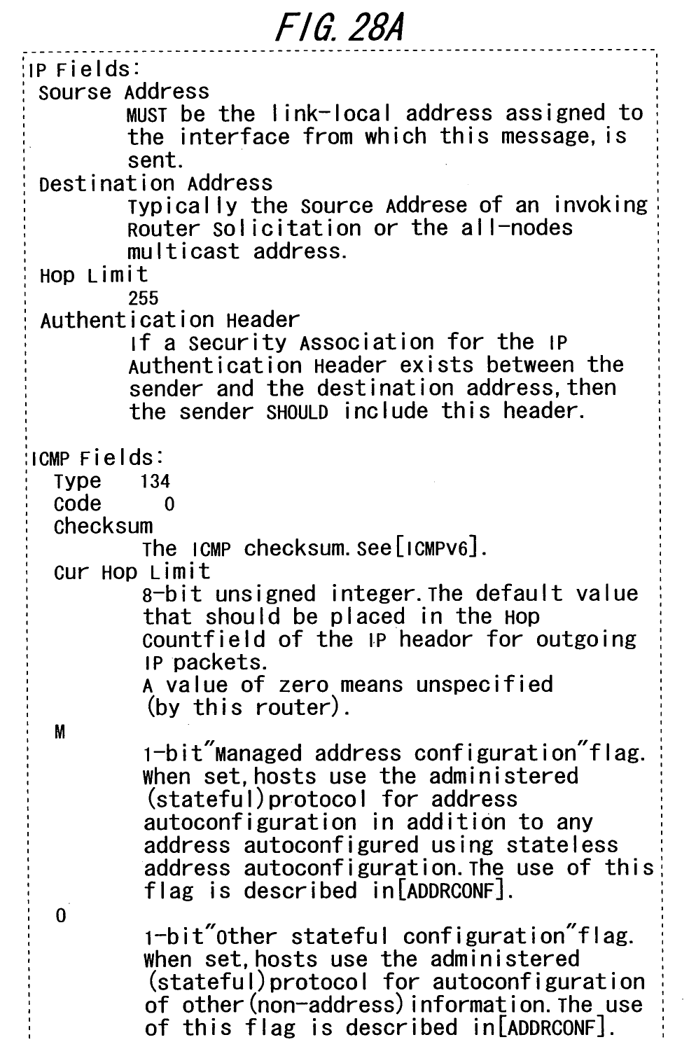

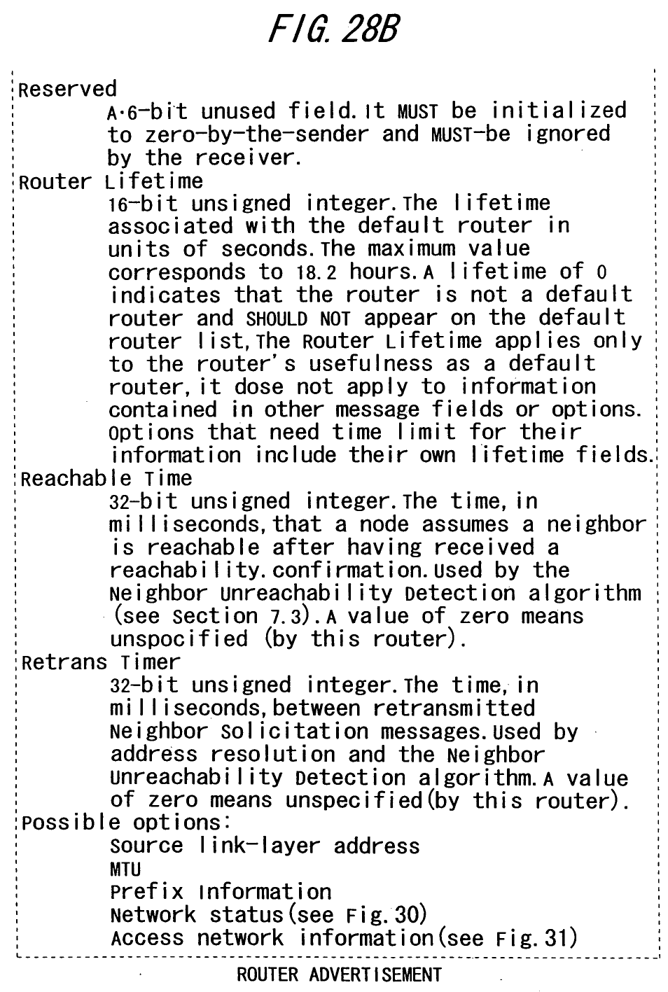

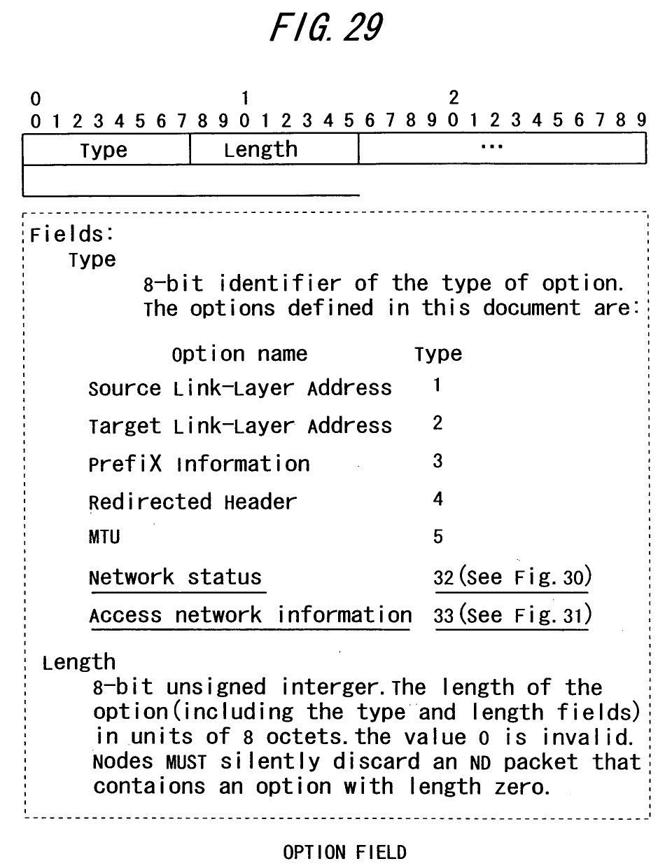

FIG. 27 is a diagram showing a message format of RA and FIG. 28 is an explanatory diagram of fields in RA. RA may have option fields where several types of information can be stored in an option field format as the one shown in FIG. 29.

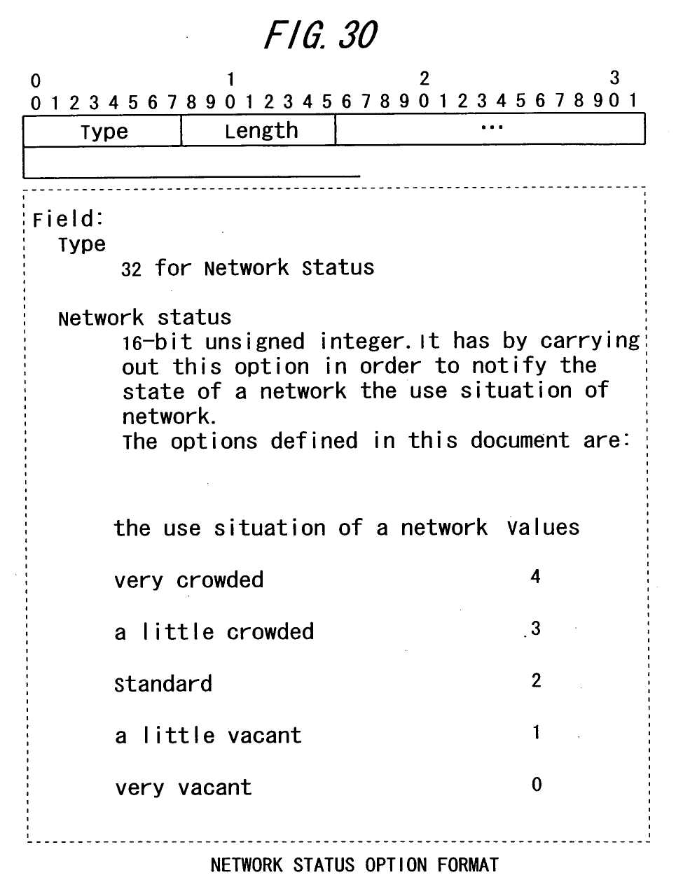

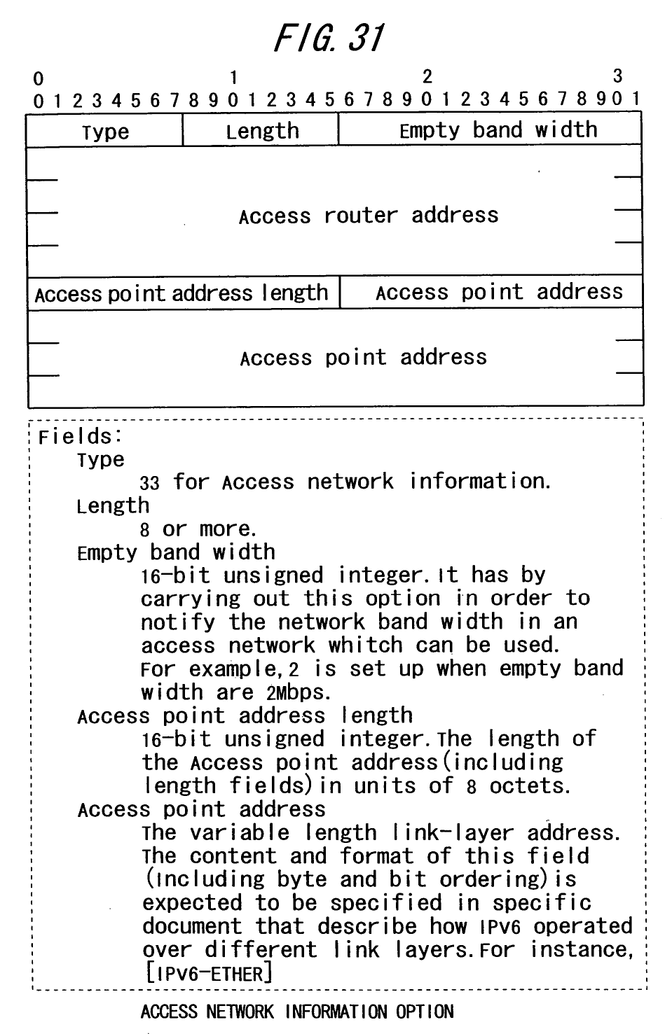

In the embodiments, network status options for notifying the network status (Network Status) as the ones shown in FIG. 30 and access network information as the one shown in FIG. 31 are added in the option format shown in FIG. 29.

As shown in FIG. 30, the option fields for the network status include areas for storing the field type (Type), the field length (Length), and the network status (Network Status). A value indicating a “network status” is stored as a field type. Stored in the network status field is a value indicating the network status which corresponds to information indicating the network status (utilization ratio, for example).

Plural network status values are prepared in accordance with information indicating network statuses. In the example of FIG. 30, five-stage network status values, “4 (congestion level (utilization ratio): highest)”, “3 (congestion level: high)”, “2 (congestion level: normal)”, “1 (congestion level: low)” and “0 (congestion level: lowest)”, are prepared in accordance with the congestion state (utilization ratio).

The option fields for access network information include areas for storing the field type (Type), the field length (Length), a free bandwidth (Empty Bandwidth), the access router address, the access point address length, and the access point address.

The embodiments employ, as an example, IP networks constituted of wireless LAN access points, typically IEEE (the Institute of Electrical and Electronic Engineers) 802.11b, for access points (access networks).

### First Embodiment

A first embodiment is an embodiment of an access router according to the present invention. The first embodiment is described with reference to the system configuration shown in FIG. 1, the access router 1000 shown in FIG. 3, the processing sequences shown in FIGS. 10, 12, 14, 15, and 17, the network information notification format shown in FIGS. 27 to 31, and the tables shown in FIGS. 4 to 9.

A network system in the first embodiment has a configuration as the one shown in FIG. 1. At least, the access router 1000 is employed as the access router 1000-1 shown in FIG. 1. The access router 1000 has the tables shown in FIGS. 4 to 9.

Employed in the first embodiment as RA to be sent from the access router 1000-1 to the host 2000 is RA that contains extra message areas (option fields) where the network status and access network information as those shown in FIGS. 27 to 31 are set.

Described in the first embodiment are (1) the operation of the access router 1000-1 sending RA in response to RS that is sent from the host 2000 belonging to the access point 4000-2 (the first processing, which corresponds to the processing 1-1 in the embodiment mode), (2) the operation of the access router 1000-1 sending RA at regular intervals (second processing, which corresponds to the processing 1-2 in the embodiment mode), and (3) the operation of the access router 1000-1 sending RA in accordance with a change in network status (third processing, which corresponds to the processing 1-3 in the embodiment mode).

<<First Processing>>

The first processing is described referring to the processing sequences shown in FIGS. 10 and 12 and the tables shown in FIGS. 4 to 7.

In FIG. 12, the network information request receiving unit 1080 of the access router 1000-1 receives RS from the host 2000 via the reception controlling unit 1070 (s201, s202, and s203). The network information request receiving unit 1080 requests the network information creating unit 1010 to create a network information notification (s204). The network information creating unit 1010 creates an RA message through the following procedure in accordance with the network information creation processing sequence shown in FIG. 10:

First, the valid period controlling unit 1011 in the network information creating unit 1010 consults the RA transmission information table (FIG. 4). The valid period controlling unit 1011 searches the RA transmission information table for a router lifetime, a possible arrival time, and a retransmission time that correspond to the network status obtained from the network status managing unit 1040, and sets the retrieved values in the valid period area in the basic message area of the RA (Router Lifetime, Possible Arrival Time, and Retransmission Time in FIG. 27) (s101A). The RA transmission table shown in FIG. 4 is structured such that a shorter valid period is set to a smaller network status indicating value (network status value).

Next, the network status addition controlling unit 1012 in the network information creating unit 1010 sends a network status inquiry request to the network status managing unit 1040 (s102 and s103).

Receiving the network status inquiry request, the network status managing unit 1040 sends, as a network status inquiry response, the network status (network status value) stored in the network status management table (FIG. 7) which corresponds to the network status notified from the network monitoring coordinating unit 1020 (s104). The network status addition controlling unit sets the network state in the network status area (FIG. 30) in the extra message area of the RA (s104A).

Then the access network information addition controlling unit 1013 in the network information creating unit sends an access network information inquiry request to the access network information managing unit 1030 (s105 and s106). Receiving the access network information inquiry request, the access network information managing unit 1030 sends, as an access network information inquiry response, the access network information stored in the access network information table (FIG. 6) (s107). The access network information addition controlling unit 1013 sets the access network information in the access network information area (FIG. 31) in the extra message area of the RA (s107A).

An RA message created in the network information creating unit 1010 is sent, in response to an RS message, at a unicast address, to the host 2000 that has sent the RS message through the network information notification sending unit and the transmission controlling unit 1100 (s205, s206, and s207). The RA message sent from the access router 1000-1 reaches the host 2000 via one of the access points 4000 (here, the access point 4000-2) (s208).

The RA message sent to the host has an extra message area in addition to the basic message area. Although not mentioned in the above description of the processing, information for enabling an existing host to connect to the core network 7000 (information such as an access router address and a network address, hereinafter referred to as “conventional information”) is set in the RA message sent to the host.

Effects derived from the first processing are as follows: When a host that sends an RS message and receives RA in return (RS sender host) in the first processing is a conventional host which is not structured according to the present invention, the conventional host has no means to recognize information stored (set) in the extra message area.

The conventional host therefore ignores the network status and access network information set in the extra message area and performs connection processing based on conventional information. Thus the conventional host is not influenced by setting information in the extra message area of the RA message.

Meanwhile, the access router 1000-1 changes the length of the valid period of network information in accordance with the network status. The access router 1000-1 sets a shorter valid period when the network congestion level is higher. In the case where the congestion level is highest, the valid period is not set at all (the network information is made invalid).

As has been described in the embodiment mode and other previous sections, with a data link connection between a conventional host and an access point established, the conventional host continues to communicate using this data link after a failure or the like makes reception of an RA message from an access router impossible.

However, when the valid period of network information which is obtained from the RA message expires, the conventional host deletes the address from an interface with which the data link is established and thereby makes the interface invalid. The conventional host therefore sends RS to the access router before the valid period expires in order to receive network information (RA) having a new valid period and maintain the connection.

If, at this point, no RA message is received within a monitoring interval, the conventional host retransmits the RS message. Irrespective of whether the number of times the RS message is sent exceeds a given retransmission count or not, as long as the data link is established, the conventional host cuts communications but maintains the connection and waits for reception of the RA message from the access router (access router 1000-1).

Since the access router 1000-1 sets a shorter valid period when the congestion level of the core network 7000 (network 7000-2) is higher, in the case where a short valid period is set, the valid period of the network information that has been received last by the conventional host expires before the next RA message is received.

In this case, the conventional host ends communications with the communication node and makes the interface invalid while maintaining the connection (data link) with the access network to which it is currently connected. The number of existing hosts connected to this access network can thus be reduced.

The access router 1000-1 can send an RA message having a valid period to each RS sender host connected to the access network. Accordingly, when congestion takes place in the core network, the access router sends RA having a short valid period to each host to thereby make the host delete the address from the interface.

With the hosts connected to the access network reduced in number, the traffic of the core network which passes this access network is reduced. This contributes to solving congestion in the core network. It is also possible to avoid congestion in the core network altogether by having the access router 1000-1 set a valid period that does not lead to congestion.

As has been described, through the first processing, the access router 1000-1 sends an RA massage that has a valid period suited to the network status to a conventional host that has sent an RS message, thereby causing the conventional host to perform processing of disconnecting from the access network (processing of cutting communications with the access router) and reducing the number of hosts that are under the control of and communicable with the access router 1000-1. Congestion in the core network thus can be solved or avoided.

Changing the valid period of network information through the series of processing enables an access router to take control of network access of hosts (access restriction).

<<Second Processing>>

The second processing is described next referring to the processing sequence of FIGS. 14 and 15 and the tables shown in FIGS. 4 to 8.

When the network 7000-2 falls in a congested state, the access router 1000-1 cooperates with the network monitoring server 3000 to receive a network status change notification (s301). The network status change notification contains information indicating the network status (network congestion information (e.g., utilization ratio), failure information, empty bandwidth, or the like), access network information, and others.

The access router 1000-1 uses the network monitoring coordinating unit 1020 to receive the network status change notification (s303). The network monitoring coordinating unit 1020 then performs network status setting processing. In other words, the network monitoring coordinating unit 1020 identifies the notified network status from conditions prescribed by the system as those shown in the network status association table (FIG. 5).

Specifically, the network monitoring coordinating unit 1020 extracts, from the network status indicating information in the network status change notification, a parameter (utilization ratio, for example) for searching the network status association table and looks up the network association table for a network status value that corresponds to the extracted parameter. The network monitoring coordinating unit 1020 sends the retrieved network status value as a network status setting request to the network status managing unit 1040 (s304).

The network state managing unit 1040 registers the network status value sent from the network monitoring coordinating unit 1020 in the network status management table (FIG. 7) (s304A). When the network status value is the same, the network status managing unit 1040 does not perform processing on the network status management table.

The network monitoring coordinating unit 1020 also performs access network information setting on the access network information managing unit 1030. In other words, the network monitoring coordinating unit 1020 sends the access network information notified from the network monitoring server 3000 to the access network information managing unit 1030 (s305). The access network information managing unit 1030 registers the received access network information in the access network information table (FIG. 6) managed by the access network information managing unit 1030 (s305A).

The network monitoring coordinating unit 1020 next requests the transmission interval controlling unit 1060 to set a network information notification transmission interval (s306). When requested to set a network information notification transmission interval by the network monitoring coordinating unit 1020, the transmission interval controlling unit 1060 inquires the network status from the network status managing unit 1040 (s307). Upon inquiry made by the unit 1020, the transmission interval controlling unit 1060 obtains, from the network state managing unit 1040, a network status value in the network status management table (FIG. 7) that reflects the network status of the core network (s308).

Once the network status value is obtained, the transmission interval controlling unit 1060 stops the network information notification transmission timer and determines a transmission interval using the transmission interval table (FIG. 9) that it manages and the obtained network status value (s308A). In other words, the transmission interval controlling unit 1060 searches the transmission interval table for a transmission interval that is associated with the network status value and determines the retrieved transmission interval as a cyclic RA message transmission interval.

After the transmission interval is determined, the transmission interval controlling unit 1060 starts the network information notification transmission timer on the newly determined transmission interval. However, when the network status value is 0, “off” is read out of the transmission interval table and transmission of the RA message is stopped.

Reception of a network status change notification causes the network monitoring coordinating unit 1020 of the access router 1000-1 to judge that the network status has been changed. Then the network monitoring coordinating unit 1020 sends a dismissal request to the connected terminal controlling unit 1050 (s309).

Receiving the dismissal request, the connected terminal controlling unit 1050 sends a network status inquiry request to the network status managing unit 1040 (s310) and receives, as a network status inquiry response, the network status (a network status value) from the network status managing unit 1040 (s311).

The connected terminal controlling unit 1050 judges whether dismissal is necessary or not based on the received network status (s311A). For instance, the connected terminal controlling unit 1050 judges whether a given judging condition “network status value <2” is satisfied or not and, when the judging condition is met (when the network status value is 1 or 0), concludes that host dismissal is necessary. When the judging condition is not met (when the network status value is 2, 3 or 4), the connected terminal controlling unit 1050 concludes that host dismissal is not necessary.

When dismissal is necessary, the connected terminal controlling unit 1050 refers to the state of connected terminals (hosts) registered in the connected terminal management table (FIG. 8) and chooses at least one host that consumes many network resources as a host to be dismissed (connected terminal to be dismissed) (s311B). For instance, out of hosts registered in the connected terminal management table, the connected terminal controlling unit 1050 decides a host whose line occupancy ratio is 3 times higher than other hosts (or a host that uses up 3 times more bandwidth than other hosts) as a host to be dismissed.

Deciding which host is to be dismissed, the connected terminal controlling unit 1050 sends, to the network information creating unit 1010, as many network information notification creation requests as the number of hosts to be dismissed (s401). The network information creating unit 1010 creates an RA message for each host to be dismissed (s401A).

Each of these RA messages has, as information for forcibly expelling a host to be dismissed from the network, control information intentionally set to cause the host to execute processing of disconnecting from an access network to which the host is currently connected immediately upon receiving and analyzing the RA message. For instance, “0 (the highest congestion level)” is set to the “network status” of the RA message as control information.

After the creation of the RA message is completed, the network information creating unit 1010 sends a network information notification transmission request message to the network information notification sending unit 1090 (s402), and sends the RA message to each host to be dismissed by unicast via the transmission controlling unit 1100 (s403, s404, and s405). A description on how network information is created is omitted since the same processing as the first operation is employed.

In the case where a host to be dismissed is the host 2000 (FIG. 19) of the present invention, the host to be dismissed monitors the network status set in an incoming RA message. When it is judged that the network status is congestion status (the network status value “0” is detected), the host to be dismissed immediately switches data links to disconnect from the current access network.

The host 2000 switches from the current access network to the one that is specified in the access network information set in the RA message. This reduces the number of hosts connected to the access network (the number of hosts that are under the control of and communicable with the access network) and accordingly congestion is solved.

On the other hand, in the case where a conventional host is a host to be dismissed, the conventional host can receive an RA message without being influenced by the extra message area. On the other hand, having no means to read the network status in the RA message, the conventional host cannot detect congestion and continues to communicate with the correspondence node 5000 via the access router 1000-1. This, however, does not present an obstacle in solving congestion since the host 2000 according to the present invention disconnects from the access network as described above, thus reducing the number of communicable hosts under the control of the access router 1000-1.

It is also possible, for example, to set a value that causes a host to be dismissed to immediately judge that the valid period has expired (invalidating value, which invalidates an interface) as the “valid period” of an RA message directed to this host.

In this case, when a conventional host is to be dismissed, the host to be dismissed receives the RA message and, detecting that the invalidating value is set to the valid period, immediately detects the address from the interface to make the interface invalid (but is not capable of switching data links). Thus conventional hosts too can forcibly be disconnected from an access network.

The series of processing enables an access router to take control of access of a specific host in accordance with the network status.

<<Third Processing>>

The third processing is described next referring to the processing sequence of FIG. 17, FIGS. 4 to 8, and the transmission interval table of FIG. 9.

When the network information notification transmission timer counts up to the specified length of time (s500), the transmission interval controlling unit 1060 of the access router 1000-1 sends a network information notification creation request to the network information creating unit 1010 (s501).

After sending the network information notification creation request, the transmission interval controlling unit 1060 searches the transmission interval table (FIG. 9) for a timer value that corresponds to the network status (a network status value managed by the network status management table (FIG. 7)). The transmission interval controlling unit 1060 determines the retrieved timer value as the time counted by the network information notification transmission timer, and resumes counting by the network information notification transmission timer.

In the case where “off” is retrieved as the RA transmission interval from the transmission interval table, the transmission interval controlling unit 1060 makes the network information notification transmission timer invalid. Since counting by the network information notification transmission timer is stopped while the network information notification transmission timer is invalid, there is no trigger for the transmission interval controlling unit 1060 to send a network information notification creation request to the network information creating unit 1010. RA messages are therefore not sent cyclically.

Network information is created (s501A) by processing equivalent to the first processing and therefore a description thereof is omitted here. After an RA message is created, the network information creating unit 1010 requests the network information notification sending unit 1090 to send a network information notification (s502) and sends, via the transmission controlling unit 1100 (s503), the RA message by multicast to every host that is under control (s504 and s505).

When a host that receives the multicast RA message is a conventional host, the conventional host can receive the RA message without being influenced by the extra message area of the RA message and can communicate with the access router 1000-1. At this point, the conventional host updates the valid period of the address given to the interface with the time notified by the RA.

However, when the interval between received RA messages becomes long and the valid period of network information expires, the conventional host invalidates the interface and cuts communications (but is incapable of switching data links). A host according to the present invention, on the other hand, switches data links. In this way, the number of hosts that are under the control of and communicable with the access router 1000-1 is reduced and congestion is solved.

The series of processing enables an access router to take control of access of a host by changing the interval of sending network information, or by stopping transmission of network information.

### Second Embodiment

A second embodiment is an embodiment of a host according to the present invention. The second embodiment is described with reference to the network configuration shown in FIG. 1, the configuration of the host 2000 shown in FIG. 19, and the processing sequences shown in FIGS. 20, 21, 23, and 25.

Described in the second embodiment are (1) the operation of the host 2000 according to the present invention to switch to a data link leading to the access point 4000-3 when an RA message is not received in response to an RS message the host 2000 has sent via the access point 4000-1 to which the host 2000 has been connected (first switching operation, which corresponds to the processing 2-1 in the embodiment mode), and (2) the operation of switching to a data link leading to the access point 4000-3 as a result of network status analysis upon reception of an RA message (second switching operation, which corresponds to the processing 2-2 in the embodiment mode).

<<First Switching Operation>>

The first switching operation is described referring to the processing sequence of FIGS. 20 and 21. The host 2000 according to the present invention receives an RA message from the access router 1000-1 connected to the access point 4000-2, to which the host 2000 belongs.

When the valid period set in the RA message expires, the interface controlling unit 2030 of the host 2000 requests the network information request sending unit 2090 to send a network information transmission request (s601). The network information request sending unit 2090 sends, via the transmission controlling unit 2100 (s602), an RS message to the access router 1000-1 (s603 and s604).

As the RS message is sent from the host 2000, the network information request sending unit 2090 requests the network information notification monitoring unit 2060 to start monitoring (s605). The network information notification monitoring unit 2060 sets the monitoring timer (s605A).

The timer interval (the time counted by the monitoring timer) is increased from 1 second to 2, 4, 8, and 10 seconds and, subsequently, is set for every 10 seconds.

When the monitoring timer counts up to the specified length of time (s605B), the network information notification monitoring unit 2060 comprises the current transmission count against a maximum retransmission count (given transmission count) prescribed by the system (s605c). In the case where the maximum retransmission count is not exceeded, the network information notification monitoring unit 2060 sends a retransmission request to the interface controlling unit 2030 (s606). Receiving the request, the interface controlling unit 2030 requires the network information request sending unit 2090 to send a network information request (s607). The network information request sending unit 2090 sends, via the transmission controlling unit 2100 (s608), the RS message to the access router 1000-1 (s609 and s610).

In the case where the current transmission count exceeds the maximum retransmission count, the network information notification monitoring unit 2060 sends, to the interface switching controlling unit 2020, a switching request due to excess of retransmission count (s612). Receiving the switching request, the interface switching controlling unit 2020 sends the switching request to the interface controlling unit 2030 (s613). The interface controlling unit 2030 responds to the switching request and performs data link switching from the access point 4000-2 to the access point 4000-3 (s613A).

After the data link switching, the interface controlling unit 2030 sends a network information request transmission request to the network information request sending unit 2090 (s614). Receiving the transmission request, the network information request sending unit 2090 sends, via the transmission controlling unit 2100 (s615) an RS message to the access router 1000-2 (s616 and s617). The network information request sending unit 2090 also requests the network information notification monitoring unit 2060 to start network information notification monitoring (s618). The network information notification monitoring unit 2060 sets the monitoring timer.

The network information notification receiving unit 2080 of the host 2000 receives an RA message from the access router 1000-2 via the reception controlling unit 2070 (s701, s702, and s703). The network information notification receiving unit 2080 then sends a request to stop network information notification monitoring to the network information notification monitoring unit 2060 (s704). The network information notification monitoring unit 2060 responds to the stopping request and stops the monitoring timer (s704A).

The network information notification receiving unit 2080 also gives the received RA message to the network information analyzing unit 2010 (s705). The host 2000 then becomes communicable with the access router 1000-2 by giving an address to the corresponding interface, or updating the address valid period, and by setting the default gateway.

The series of processing enables the host 2000 to switch data links and connect to a different access network when the maximum retransmission count is exceeded without receiving an RA message.

<<Second Switching Operation>>

The second switching operation is described next referring to the processing sequences of FIGS. 23 and 25. An RA message from the access router 1000-1 is received by the reception controlling unit 2070 of the host 2000 (s801 and s802) and then sent, via the network information notification receiving unit 2080 (s803), to the network information analyzing unit 2010 (s804).

The network information analyzing unit 2010 obtains, from the received RA message, the network status, access network information, and the valid period (s804A, s804B, and s804C). Then the network information analyzing unit 2010 refers to the network status (the network status value set as the network status in the extra message area by the access router 1000-1 (FIG. 30)) to judge whether the communication quality demanded by the host 2000 is met or not (s804D). For instance, the network information analyzing unit 2010 judges that the demanded communication quality is not met when the network status value is smaller than a given value (e.g., when the network status value is smaller than 2).

When it is judged that the communication quality is satisfactory (s805), the address controlling unit 2040 gives an address, or updates the valid period, via the interface controlling unit 2030 (s806 and s806A), the path controlling unit 2050 sets a path, and the access router 1000-1, which is the sender of the RA message, is set as the default gateway of the host 2000 (s807 and s807A).

On the other hand, when it is judged that the communication quality is unsatisfactory (s808), the interface switching controlling unit 2020 sends a switching request to the interface controlling unit 2030 (s901). The interface controlling unit 2030 searches for an access point according to the switching request. The interface controlling unit 2030 finds the access point 4000-3 and then switches data links to switch the access point to which the host is connected from the access point 4000-2 to the access point 4000-3 (s901A).

Thereafter, the interface controlling unit 2030 requires the network information request sending unit 2090 to send a network information request (s902). The network information request sending unit 2090 sends an RS message via the transmission controlling unit 2100 (s903, s904, and s905). At the same time, the interface controlling unit 2030 requests the network information notification monitoring unit 2060 to start network information notification monitoring (s906). The network information notification monitoring unit 2060 starts the monitoring timer (s906A).

The network information notification receiving unit 2080 receives an RA message from the access router 1000-2 via the reception controlling unit 2070 (s907, s908, and s909), and then sends a network information notification monitoring stopping request to the network information notification monitoring unit 2060 (S910). The network information monitoring unit 2060 receives the stopping request and then stops the monitoring timer (s910A). The network information notification receiving unit 2080 also sends the received RA message to the network information analyzing unit 2010 (s911).

The series of processing enables the host 2000 to switch access networks. In the case where the network status does not meet the communication quality that the host 2000 demands, the host 2000 performs processing of disconnecting from the current access network and connecting to another access network.

### Third Embodiment

A third embodiment is an embodiment of a network system that includes an access router and host according to the present invention. The third embodiment is described with reference to the system configuration diagram shown in FIG. 1, the access router 1000 shown in FIG. 3, the host 2000 shown in FIG. 19, and the processing sequences of FIGS. 17, 23, and 25.

As shown in FIG. 1, the host 2000 belongs to the access point 4000-2 and is connected to the access router 1000-1 via the hub 6000. Described in the third embodiment is the operation of switching data links in order to switch to the network 7000-3 to which the access router 1000-2 belongs by reconnecting the host 2000 to the access point 4000-3 upon reception of an RA message from the access router 1000-1 after the network 7000-1 falls into a congestion state.

In the processing sequence of FIG. 17, the transmission interval controlling unit 1060 in the access router 1000-1 requests, when the network information notification transmission timer counts up to the specified length of time (s500), the network information creating unit 1010 to create a network information notification (s501).

While requesting to create a network information notification, the transmission interval controlling unit 1060 simultaneously restarts the network information notification transmission timer (s500A). Network information is created (s501A) by the same operation as described in the first embodiment and therefore a description thereof is omitted here.

After an RA message is created, the network information creating unit 1010 requests the network information notification sending unit 1090 to send a network information notification (s502) and sends, via the transmission controlling unit 1100 (s503), the RA message by multicast to every host that is under the control of the access router 1000-1 (s504, and s505).

In the host 2000, as shown in FIG. 23, the multicast RA message from the access router 1000-1 is received by the reception controlling unit 2070 (s801 and s802) and then sent, via the network information notification receiving unit 2080 (s803), to the network information notification analyzing unit 2010 (s804). The network information notification analyzing unit 2010 obtains, from the received RA message, the network status (the network status value in the extra message area) (FIG. 30), access network information (FIG. 31), and the valid period (Router Lifetime, Reachable Time, and Retrans (Retransmission) Timer in FIG. 27).

Then the network information notification analyzing unit 2010 refers to the obtained network status and, when it is judged that the communication quality demanded by the host 2000 is met (s805), the address controlling unit 2040 gives an address, or updates the valid period, via the interface controlling unit 2030 (s806 and s806A). Also, through the interface controlling unit 2030, the path controlling unit 2050 sets a path and the access router 1000-1, which is the sender of the RA message, is set as the default gateway of the host 2000 (s807 and s807A).

On the other hand, when it is judged that the communication quality demanded by the host 2000 is not met (s808), the interface switching controlling unit 2020 sends a switching request to the interface controlling unit 2030 as shown in FIG. 25 (s901).

The interface controlling unit 2030 searches for an access point according to the switching request. The interface controlling unit 2030 finds the access point 4000-3 and then switches data links to switch the access point to which the host is connected from the access point 4000-2 to the access point 4000-3 (s901A).

Thereafter, the interface controlling unit 2030 requests the network information request sending unit 2090 to send a network information request (s902). The network information request sending unit 2090 sends an RS message via the transmission controlling unit 2100 (s903). The RS message reaches the access router 1000-2 via the access point 4000-3 (s904 and s905). The network information request sending unit 2090 requests, at the same time the RS message is sent, the network information notification monitoring unit 2060 to start network information notification monitoring (s906). The network information notification monitoring unit 2060 starts the monitoring timer (s906A).

The network information notification receiving unit 2080 receives an RA message from the access router 1000-2 via the reception controlling unit 2070 (s907, s908, and s909). The network information notification receiving unit 2080 then sends a request to stop network information notification monitoring to the network information notification monitoring unit 2060 (s910). The network information notification monitoring unit 2060 responds to the stopping request and stops the monitoring timer (s910A).

The network information notification receiving unit 2080 also gives the received RA message to the network information notification analyzing unit 2010 (s911). The series of processing provides the effects described in the first and second embodiments, and makes it possible to switch access networks (data links) based on the network status that is set in an RA message.

### Fourth Embodiment

A fourth embodiment is described with reference to the system configuration shown in FIG. 1, the access router 1000 shown in FIG. 3, the host 2000 shown in FIG. 19, the processing sequences of FIGS. 14, 15, 23, and 25, and the tables shown in FIGS. 7, 8, and 9.

As shown in FIG. 1, the host 2000 belongs to the access point 4000-2 and is connected to the access router 1000-1 via the hub 6000. Described in the fourth embodiment is the operation of switching data links in order to switch to the network 7000-3 to which the access router 1000-2 belongs by connecting the host 2000 to the access point 4000-3 upon reception of an RA message from the access router 1000-1 after the network 7000-2 falls into a congestion state.

In the processing sequence of FIGS. 14 and 15, when the network 7000-2 to which the access point 4000-2 and the access router 1000-1 belong fall into a congestion state, the network monitoring server 3000 first sends a network status change notification to the access router 1000-1. The congestion lowers the throughput in the host 2000.

When the access router 1000-1 receives the network status change notification indicating that the network 7000-2 is in a congestion state (s301 and s303), the network status contained in the network status change notification is set in the network status managing unit 1040 (s304 and s304A), the access network information is stored in the access network information management unit 1030 (s305 and s305A), and a dismissal request is sent to the connected terminal controlling unit 1050 (s309).

The connected terminal controlling unit 1050 inquires the network status from the network status managing unit 1040 (s310) and obtains the network status (the network status value stored in the network status management table (FIG. 7)) in response (s311). The connected terminal controlling unit 1050 judges whether or not host dismissal is necessary from the obtained network status (s311A) and, when host dismissal is necessary, uses the same method as in the first embodiment to decide which host (terminal) is to be dismissed.

In the case where the host 2000 is determined as a host to be dismissed, the same method as in the first embodiment is used to create an RA message in the network information creating unit 1010, and the RA message is sent by unicast to the IP address of the host 2000 from the network information notification sending unit 1090 (s401, s401A, s402, and s403).

However, in creation of an RA message, if the RA message is to have access network information added, the access network information addition controlling unit 1013 searches the access network information table (FIG. 6) for access network information that improves the throughput of the host 2000 and adds the access network information to the RA message. In this example, an entry about to the access point 4000-3 is read from the viewpoint of finding an access network that improves the throughput, and is set as access network information in the extra message area (FIG. 31) of the RA message.

Information on the access point 4000-3 (access network information) is sent from the network monitoring server 3000 to the access router 1000-1, and is managed by the access network information managing unit 1030. The unit 1030 manages as information components at least a MAC address to which the connection is to be switched, the throughput (empty bandwidth), and an upper level router (access router that houses the access point) (see FIG. 6).

Next, the processing sequences of FIGS. 23 and 25 are used to describe the operation of the host 2000 upon reception of an RA message from the access router 1000-1. When the host 2000 receives the RA message (s801, s802, s803, and s804), the network information notification analyzing unit 2010 detects that the network is in a congestion state from the network status contained in the RA.

From the network status value of the RA, the network information notification analyzing unit 2010 judges that the network in a congestion state and that the congestion is preventing the network from satisfying the communication quality of the host 2000 (bandwidth necessary for an application loaded in the host 2000) (s804D).

The network information notification analyzing unit 2010 in this case consults the network information in the RA message, and when the throughput of the access point 4000-3 is higher than the current throughput of the host 2000, determines the access point 4000-3 as an access point to be switched to. Then, the interface switching controlling unit 2020 takes over the processing from the unit 2010 (s808).

The interface switching controlling unit 2020 sends a switching request for the access point 4000-3 to the interface controlling unit 2030 (s901). The interface controlling unit 2030 responds to the switching request and switches from the access point 4000-2 to the access point 4000-3 (s901A). Thereafter, an RS message is sent to the access router 1000-2, which is a router above the access point 4000-3 (s902, s903, s904, and s905).

When sending the RS message, the network information notification monitoring unit 2060 sets the monitoring timer (s906) If an RA message from the access router 1000-2 is received, in response to the RS message sent (s907, s908, s909), before the monitoring timer finishes counting up the specified length of time, the monitoring timer stops counting (s910, s910A).

The RA message is handed over to the network information notification analyzing unit 2010 (s911), and the network status is judged from the network status value contained in the RA message (s911). When it is judged the network status is satisfactory, the access router 1000-2 is set as the default gateway and communications are started. Processing steps subsequent to Step s911 are identical to Steps 804A to s807A shown in FIG. 23.

The series of processing provides effects similar to those in the first and second embodiments. Moreover, a switching can be executed on the assumption that an improvement in throughput is ensured when access networks are switched by consulting access network information contained in an RA message and by following this access network information. In other words, a switching can be made to an access network that improves the communication quality.

[Others]

The embodiment mode and embodiments described above disclose the following claimed inventions. The plural inventions listed below maybe combined with one another if necessary. The following claimed invention may be identified as method inventions.

What is claimed is:

1. An access router placed at an entrance of a first network to accommodate a second network through which a terminal device connects to the first network, comprising:
a creating unit creating network information having control information to control connection of the terminal device to the second network; and
a transmitting unit sending the network information with the control information to the terminal device connected to the second network.

2. An access router according to claim 1, wherein the creating unit creates the network information with the control information when receiving a network information transmission request from a terminal device connected to the second network, and
wherein the transmitting unit sends, by unicast, the network information with the control information to the terminal device as a source of the transmission request.

3. An access router according to claim 1, wherein the creating unit creates the network information with the control information upon a change in state of the first network, and
the creating unit sends, by unicast, the network information with the control information to at least one specific terminal device connected to the second network.

4. An access router according to claim 1, wherein the creating unit periodically creates the network information with the control information, and
the transmitting unit sends, by multicast, the periodically created network information with the control information to each terminal device connected to the second network.

5. An access router according to claim 1, wherein the control information contain information for causing a terminal device connected to the second network to perform processing of disconnecting from the second network, or causing the terminal device to terminate or interrupt a communication with the access router.

6. An access router according to claim 1, wherein the control information includes a valid period of the network information, and
the transmitting unit sends the network information with the control information to a terminal device that is to perform processing of disconnecting from the second network, or terminating or interrupting a communication with the access router when the valid period expires.

7. An access router according to claim 1, further comprising:
a network status managing unit managing a status of the first network;
a terminal device managing unit managing information of a terminal device connected to the second network; and
a determining unit determining at least one terminal device that is to cut the connection to the second network in accordance with the status of the first network,
wherein, the creating unit creates the network information with the control information that causes said at least one of the terminal devices to perform disconnection processing, and
the transmitting unit sends the network information with the control information to said at least one of the terminal devices.

8. An access router according to claim 7, wherein the control information for causing said at least one of the terminal devices to perform disconnecting processing contain a status of the first network in which said at least one of the terminal devices performs processing of disconnecting from the second network.

9. An access router according to claim 1, further comprising:
a network status managing unit managing a status of the first network; and
a transmission interval determining unit determining, in accordance with the status of the first network, transmission intervals of the periodically sent network information with the control information,
wherein the transmitting unit periodically sends the network information with the control information at the transmission intervals.

10. An access router according to claim 9, wherein the transmission interval determining unit determines to stop periodic transmission of the network information with the control information in accordance with the status of the first network.

11. An access router according to claim 1, further comprising:
a second network information managing unit managing information of each second network connected to the first network,
wherein the creating unit creates the network information with the control information that contain information of another second network.

12. A terminal device connected via a second network to an access router, which is placed at an entrance of a first network, comprising:
a receiving unit receiving network information from the access router via the second network;
a monitoring unit monitoring reception of the network information; and
a connection/disconnection processing unit performing processing of connecting to the second network and processing of disconnecting from the second network when the monitoring unit can not detect reception of network information for a given period of time.

13. A terminal device connected via a second network to an access router, which is placed at an entrance of a first network, comprising:
a receiving unit receiving network information which has control information from the access router via the second network;
an analyzing unit analyzing the received network information with the control information; and
a connection/disconnection processing unit performing processing of connecting to the second network and processing of disconnecting from the second network in accordance with results of an analysis by the analyzing unit.

14. A terminal device according to claim 13, wherein the control information contain information for forcing the connection/disconnection processing unit to perform the disconnecting processing.

15. A terminal device according to claim 13, wherein the control information contain the status of the first network,
the analyzing unit judges from the status of the first network whether or not a communication quality requested by the terminal device is satisfied, and
the connection/disconnection processing unit performs the disconnecting processing when the communication quality is not satisfied.

16. A terminal device according to claim 12, wherein, after the disconnecting processing, the connection/disconnection processing unit searches for a second network different from the disconnected second network, and performs processing of connecting to the second network found.

17. A terminal device according to claim 12, wherein the network information having the control information contain information on a second network different from the one to which the terminal device is currently connected, and
after the disconnecting processing, the connection/disconnection processing unit uses the information on the different second network to perform processing of connecting to the different second network.

18. A terminal device according to claim 12, wherein the analyzing unit refers to the information on the different second network, compares a communication quality of the case where the terminal device is connected to the different second network with the current communication quality, and decides to switch to the different second network if the former is better than the latter, and
the connection/disconnection processing unit follows the decision to switch and performs processing of switching to the different second network.

19. A method of controlling connection of a terminal device to a network by an access router, the access router placed at an entrance of a first network to accommodate a second network through which a terminal device connects to the first network, the method comprising:
creating network information having control information to control connection of the terminal device to the second network; and
sending network information having the control information to the terminal device connected to the second network.

20. A method of controlling connection of a terminal device to a network, the terminal device being connected to an access router, which is placed at an entrance of a first network, via a second network, the method comprising:
performing processing of connecting to the second network;
monitoring reception of network information arrived from the access router via the second network; and
performing processing of disconnecting from the second network when the reception of the network information can not be detected for a given period of time.

21. A method of controlling connection of a terminal device to a network, the terminal device being connected to an access router, which is placed at an entrance of a first network, via a second network, the method comprising:
performing processing of connecting to the second network;
receiving network information which has control information from the access router via the second network;
analyzing the received network information which has control information; and
performing processing of disconnecting from the second network in accordance with results of the analysis.
